(19) United States
(12) Patent Application Publication
(10) Pub. No.: US 2014/0052576 A1
(43) Pub. Date: Feb. 20, 2014

(54) SYSTEM FOR SUPPORTING INTERACTIVE COMMERCE TRANSACTIONS AND SOCIAL NETWORK ACTIVITY

(71) Applicants: Deana Zelenka, Downingtown, PA (US); Jay Samuel Dantinne, Philadelphia, PA (US); Robin Christopher Gingras, Philadelphia, PA (US); Chiranjiv Singh Jouhal, Gwynedd Valley, PA (US); Guruvayurappan Srinivasan, Chester Springs, PA (US); James Tierney, Yardley, PA (US); Josiah Kiehl, Philadelphia, PA (US); Pete Borowsky, Yardley, PA (US); Dan Guy, Swiftwater, PA (US)

(72) Inventors: Deana Zelenka, Downingtown, PA (US); Jay Samuel Dantinne, Philadelphia, PA (US); Robin Christopher Gingras, Philadelphia, PA (US); Chiranjiv Singh Jouhal, Gwynedd Valley, PA (US); Guruvayurappan Srinivasan, Chester Springs, PA (US); James Tierney, Yardley, PA (US); Josiah Kiehl, Philadelphia, PA (US); Pete Borowsky, Yardley, PA (US); Dan Guy, Swiftwater, PA (US)

(73) Assignee: ZECOZI, INC., Franklinville, NJ (US)

(21) Appl. No.: 13/823,529

(22) PCT Filed: Sep. 19, 2011
(86) PCT No.: PCT/US11/52160

§ 371 Date: Nov. 1, 2013

Related U.S. Application Data
(60) Provisional application No. 61/383,932, filed on Sep. 17, 2010.

(51) Int. Cl. G06Q 30/06

(52) U.S. Cl. CPC G06Q 30/0613
USPC 705/26.41

(57) ABSTRACT

The disclosed subject matter includes an electronic commerce platform for a user to buy and sell goods and services, as well as a social network platform for a user to socially interact with other users. The combination of these two activities enables the user to solicit information online from other users of the system prior to buying or selling a product or service. The user can also share purchase information as well as information about favorite products, services, sellers, etc. with other users. This interconnected relationship between social connections and buying and selling activities support an entire new set of information available to the community of users of the system and greatly improves their purchasing and selling decision making processes.

### TECHNICAL FIELD

The presently disclosed subject matter relates to electronic commerce via an electronic communications network, such as the Internet.

### BACKGROUND ART

The Internet is an electronic communication network, which is an important source of information for individuals and businesses. The Internet provides the underlying infrastructure for another network known as the World Wide Web (often referred to as the “Web” or by the acronym “WWW”). With the popularization of the World Wide Web, businesses began selling products and services through the Web, a practice that is commonly referred to as electronic commerce, or “e-commerce” for short. E-commerce continues to grow, as it provides consumers access to products and services that had previously been inaccessible or, at least, not easily accessible.

### DISCLOSURE OF INVENTION

This document references terms that are used consistently or interchangeably herein. These terms, including variations thereof, are as follows.

The term “account” means a set of information associated with a particular person or entity (“user”) in connection with a service or system operating via an electronic communications network. An account may, but not necessarily, include financial or other personally identifying information and is usually associated with a unique user name and password.

The term “avatar” means a visual representation of a person or entity in an electronic communications network, such as the Internet.

The term “click”, “clicks”, “click on”, “clicks on” involves the activation of a location on a computer screen (monitor) or computer screen display, for example, an activatable portion or link, that causes an action of the various software and or hardware supporting the computer screen display. This may be accomplished, for example, with computer pointing apparatus, such as a device commonly known as a mouse, or with a finger tapping on a touchscreen.

A “client” is an application that runs on a computer, workstation or the like and relies on a server to perform some operations, such as sending and receiving email. Accordingly, a “client computer” is a computer running a client.

The term “collaborative shopping” means simultaneously and collaboratively sharing information and opinions with other people about products and services viewable on an electronic communications network, such as the Internet, in order to make informed and well-considered purchasing decisions. An example of a service for facilitating collaborative shopping is Shared Shopping™ from Zecozi, Inc. of Franklinville, N.J.

“Favorites” in the description below are items such as listings and sellers which a user has indicated agreement or support for. In certain embodiments, this is done by clicking a link or icon associated with the item to be deemed a favorite by a given user. Examples such items deemed as favorites are Scoops™ from Zecozi, Inc. of Franklinville, N.J.

“n” and “nth” in the description below and the drawing figures represent the last member of a series or sequence of servers, databases, caches, components, listings, links, data files, etc.

The term “profile” means information associated with a person or entity (“user”) in connection with a service or system operating via an electronic communications network. Generally, some or all of the information in a profile is viewable by other users.

A “server” is typically a remote computer or remote computer system, or computer program therein, that is accessible over a communications medium, such as the Internet, that provides services to other computer programs (and their users), in the same or other computers.

The term “social network” means, in the database of a system that manages relationships between people on a global communications network, a set of people, each having a profile on the service and whose profiles are linked directly or indirectly to one another. The social network of any particular person is the set of people whose profiles are linked directly or indirectly to that person's profile. A direct link between two people's profiles generally results when people mutually agree to be directly related and notify the system of their agreement. An indirect link between a first person's profile and a second person's profile is present when they are not directly linked and a third person's profile is directly linked to both the first and second persons' profiles.

A “tiered social network” is a type of social network wherein profiles that are directly linked are considered to be on a first degree of connection or “tier” with respect to one another while indirect links are considered to be on an (p+1)th tier with respect to one another, wherein p represents the number of people whose profiles are needed to indirectly link the two people together. An example of a tiered social network is Zecozi Loop™ from Zecozi, Inc. of Franklinville, N.J.

A “uniform resource locator” (“URL”) is the unique address for a file, such as a web site or a web page, that is accessible on the Internet.

A “user interface” is a component of a computer system or program that provides information, visually, audibly, or otherwise, to a user and also provides a means through which the user can enter information and issue commands to the computer system or program.

The term “user” in the context of the presently disclosed subject matter means a person or entity that interacts with and performs operations through a system or service on an electronic communications network.

A “web site” or “website” is a related collection of World Wide Web (WWW) files that includes a beginning file or “web page” (also “webpage” or “page”) called a home page, and typically, additional files or “web pages.” The term “web site” is used collectively to include “web site” and “web page(s).”

The present disclosed subject matter relates to electronic commerce integrated with and social interaction, via an electronic communications network, for example, the Internet or other public network, or other wide area network.

The present disclosed subject matter provides a system that includes both an e-commerce platform for a user to buy and sell goods and services as well as a social network platform for a user to socially interacting with other people. The combination of these two activities enables the user to solicit information online from other users, including friends, family, coworkers, sellers, and any other person that uses the system prior to buying or selling. The input from the user's social connections can greatly improve the decision making process of the user. The user can also share purchase information as well as information about favorite products, services, sellers, etc. with other users of the system. Sharing this information enables other users of the system to improve their decision making process as well. Knowing the e-commerce activities of other users allows a user to reach out to others, knowing that the other person can likely provide valuable insight. This interconnected relationship between social connections and buying and selling activities support an entire new set of information available to the community of users of the system.

The present disclosed subject matter also provides a user interface for participating in and managing instances of collaborative shopping. The user interface includes a visual element shaped as a bar, hereinafter the “collaborative shopping bar” and another visual element shaped as a panel, referred to herein as the “collaborative shopping panel.” Both the collaborative shopping bar and the collaborative shopping panel appear within a web browser and overlay any website pages viewed in the web browser.

The aforementioned user interface allows users to create instances of collaborative shopping, referred to herein as a “collaborative shopping session” or, more simply, a “session.” A user creates a collaborative shopping session with one or more other users by sending an invitation to one or more other users, for example over an internal message system, email, short message service (“SMS”), or multimedia message service (“MMS”). Once a session is started, additional users may be added by members of the session. Once users are in a session, text and images provide a visual indicator of which users are in a session. Once in a shared session, users of that session can optionally communicate with each other, for example through internal text messages. Users can optionally share the web pages they are visiting, which sends a uniform resource locator (“URL”) to all other users in the session. In some embodiments of the disclosed subject matter, the user interface shows an indicator or text and images to notify user that a page is being shared by another user. Users have the option of viewing pages shared by other users. Viewing a shared page replaces the current website page a user is viewing with the shared page. The user can interact with the shared page as he or she can with any other viewed page.

User interface controls are overlaid on the shared page so that the user can return to his or her previously viewed page or set the shared page as the currently viewed page. Either action removes the overlaid controls. A user can have multiple collaborative shopping sessions, each with multiple users concurrently. A user can exit a session, create a session, accept an invitation to a session, and participate within sessions at any time from within the collaborative shopping bar and collaborative shopping panel.

Also included in the present disclosed subject matter is a system that enables users to invite another user to establish a connection between them. This connection enables the users to share information with each other, communicate with each other, and to view each other's connections with other users. A user's connections are considered his or her “direct” connections or “1st degree” connections. The user's 1st degree connection's connections are considered “2nd degree” connections. The user's 2nd degree connection's connections are considered 3rd degree connections, and so on. The system enables the user to share information and communicate with all degrees of connections. To control how information is shared, the user can assign each connection to a specific set. These sets of connections are called “Loops.” The user can select which Loop people belong to and at a later time move a person from one Loop to another. In order to selectively share information with users within Loops, the system organizes data into individual or sets of data fields. Each individual field or set of fields can be configured to a privacy setting.

The privacy settings enable the user to share information from a field or set of fields with a single Loop, all Loops, all users of the system, or to no users of the system. This functionality enables the user to have complete control of how information is shared. Also, the user can select whether the user appears available on the system to a single Loop, all Loops, all users of the system, or to no users of the system. This enables the user to control whether he or she appears to be online and available to communicate with, or offline and unavailable to communicate with, other users. Therefore the user can use the site privately if he or she chooses or more publically, if he or she wants to interact with others while using the system.

Additionally, information can be shared amongst users of the system who belong to “Groups.” Groups are associations of users wherein information pertaining to a particular category of products or listings is shared. In the following description of the present disclosed subject matter, the joining of one or more Groups and sharing of information among users in one or more Groups is explained.

### BRIEF DESCRIPTION OF DRAWINGS

Attention is now directed to the drawing figures, where like or corresponding numerals indicate like or corresponding components. In the drawings:

FIG. 1 is a high-level system architecture diagram of an exemplary system supporting the disclosed subject matter.

FIG. 2 is a diagram focusing on the transfer, storage, and processing of data in an exemplary system supporting the disclosed subject matter.

FIG. 3A is a diagram of an exemplary database entry for storing information about a user of an exemplary system supporting the disclosed subject matter.

FIG. 3B is a diagram of an exemplary database entry for storing information about connections or associations between users in an exemplary system supporting the disclosed subject matter.

FIG. 3C is a diagram of an exemplary database entry for storing profiles in an exemplary system supporting the disclosed subject matter.

FIG. 3D is a diagram of an exemplary database entry for storing information about listings of products or services available to be purchased or sold in an exemplary system supporting the disclosed subject matter.

FIG. 4 is a flow diagram (flow chart) of an exemplary process including reviewing, discussing, and purchasing a product associated with a listing in accordance with an exemplary system supporting the disclosed subject matter.

FIG. 5 is a diagram of a user interface in accordance with the system of the present disclosed subject matter showing listings.

FIG. 6 is a diagram of a user interface in accordance with the system of the present disclosed subject matter showing a profile.

FIG. 7 is a diagram of a user interface for conducting Collaborative Shopping in accordance with the system of the present disclosed subject matter.

FIG. 8 is a diagram of a user interface showing the Commerce Wall in accordance with the system of the present disclosed subject matter.

FIG. 9 shows a diagram of a user interface in accordance with the system of the present disclosed subject matter showing search results.

FIG. 10 is a diagram focusing on the transfer, storage, and processing of data in an exemplary system supporting the disclosed subject matter.

FIG. 11 is a diagram of an exemplary database entry for storing information about collaborative shopping sessions in an exemplary system supporting the disclosed subject matter.

FIGS. 12A through 12B are flow diagrams (flow charts) of an exemplary process of conducting a collaborative shopping session in an exemplary system supporting the disclosed subject matter.

FIG. 13 is a diagram of a user interface in an exemplary system supporting the disclosed subject matter.

FIG. 14 is a diagram of a user interface in an exemplary system supporting the disclosed subject matter.

FIG. 15 is a diagram of a user interface in an exemplary system supporting the disclosed subject matter.

FIG. 16 is a diagram focusing on the transfer, storage, and processing of data in an exemplary system supporting the disclosed subject matter.

FIG. 17 is a diagram of an exemplary database entry for storing information about a Loop in an exemplary system supporting the disclosed subject matter.

FIG. 18 is a flow diagram (flow chart) of an exemplary process of managing a Loop in an exemplary system supporting the disclosed subject matter.

FIG. 19 is a diagram of a user interface for managing a Loop in an exemplary system supporting the disclosed subject matter.

FIG. 20 is a diagram of a user interface pertaining to a profile in an exemplary system supporting the disclosed subject matter.

FIG. 21 is a diagram of a user interface for setting a user's availability in an exemplary system supporting the disclosed subject matter.

FIG. 22 is a diagram of a user interface showing a listing in accordance with an alternative embodiment of a system in accordance with the present disclosed subject matter.

FIG. 23 is a diagram of a user interface showing a listing in accordance with yet another embodiment of a system in accordance with the present disclosed subject matter.

FIG. 24 is a diagram of a user interface showing a profile in accordance with an alternative embodiment of a system in accordance with the present disclosed subject matter.

FIG. 25 is a diagram of a user interface showing a profile in accordance with yet another alternative embodiment of a system in accordance with the present disclosed subject matter.

FIG. 26 is a diagram of a user interface showing search results in accordance with an alternative system in accordance with the present disclosed subject matter.

FIG. 27 is a diagram of a user interface for managing one or more Loops in an alternative embodiment of a system in accordance with the present disclosed subject matter.

FIG. 28 is a diagram of a user interface for managing the sharing of an item of information in an alternative embodiment of a system in accordance with the present disclosed subject matter.

FIG. 29 is a diagram of a user interface for presenting recent shared activity and information to a user in an alternative embodiment of a system in accordance with the present disclosed subject matter.

FIG. 30 is a diagram of an exemplary database entry for storing information about a Group in an exemplary system supporting the disclosed subject matter.

### MODES FOR CARRYING OUT THE INVENTION

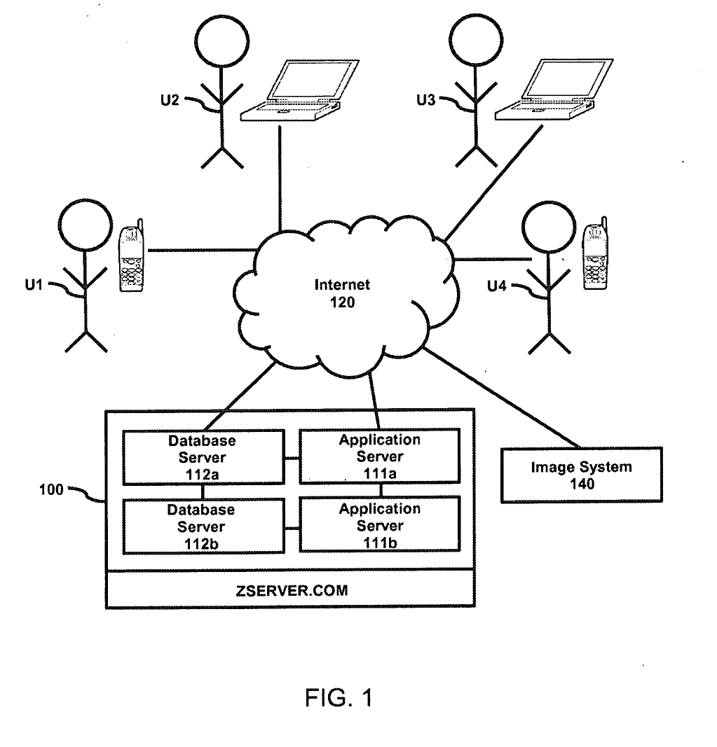

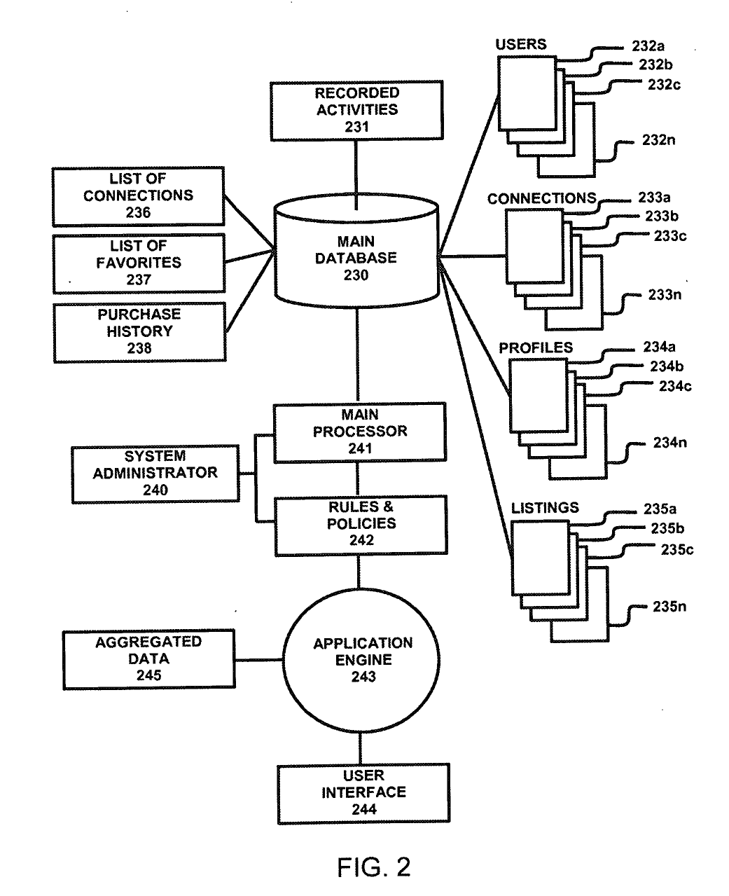

FIG. 1 is a high-level system architecture diagram of an exemplary system supporting the disclosed subject matter. Users (U1-U4) connect to the ZSERVER.COM website 100 (the “system”) via computing and mobile devices (“client computers”) over the Internet. All users connect to system 100 Application Servers 111a, 111b which each contain at least one central processing unit (“CPU”), memory, and computer-executable instructions stored in the memory for processing transactions that take place during the initiation, pendency, or conclusion of a collaborative shopping sessions as well as all other transactions ancillary or necessary to enable collaborative shopping. The Application Servers are connected to Database Servers 112a, 112b which store all system 100 records and transactions in the Main Database 230, shown in FIG. 2. The Application Servers also connect to Image Systems 114 (for Example Amazon S3) over an electronic communications network, such as the Internet 120 to add, remove, and view images.

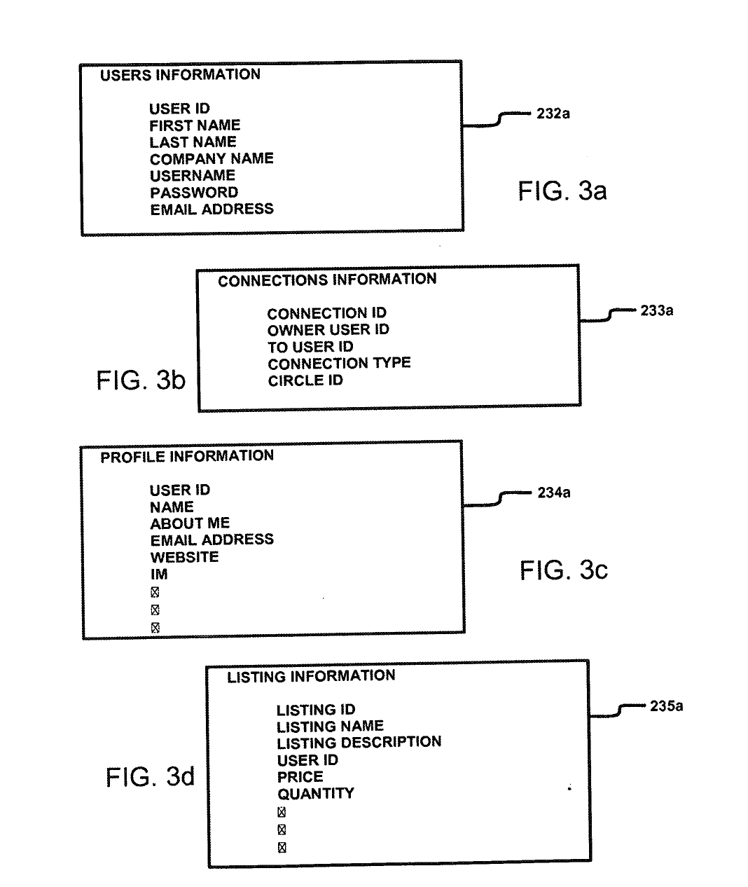

FIG. 2 is a diagram focusing on the transfer, storage, and processing of data in an exemplary system supporting the disclosed subject matter. FIGS. 3A through 3D are diagrams of an exemplary database entries for storing information in an exemplary system supporting the disclosed subject matter. The Main Database 230 stores all data or references to external data for example, images. The following types of data are managed by the Main Database 30:
User Records 232a-232n, shown in FIG. 3A: When a user registers with the system 10, the system 10 generates a User record 232a-232n including a User ID generated by the system 10 as a unique identifier for the user, First Name, Last Name, Company Name, Username as selected by the user, Password, and Email Address of the user.
Each time one user establishes a connection with another user, the system generates a Connection record 233a-233n, which identifies the Connection ID generated by the system, Owner User ID of the user initiating the connection, To User ID of the user receiving the connection request, Connection Type to indicate how the connection was made, and Circle ID to indicate the Loop the connection is assigned to.
Each user 232a has the option of creating a profile 234a that includes personal information about himself or herself. Profile 234a information includes a Profile ID as a unique identifier, a User ID to link the profile to the user it was created by and various personal information such as, but not limited to name, a narrative about the person, email address, website, IM, etc.
The commerce activity of the system centers around listings 235a-235n, which represent products or services. Listings 235a-235n can be purchased or sold. Listings 235a-235n includes a Listing ID as a unique identifier, User ID to indicate which user is selling the listing, and other information such as, but not limited to, listing name, listing description, price, and quantity.
List of Connections 236 are used to assign a connection to a Loop.
List of Favorites 237 includes all information that can be set as a favorite on the website, such as, but not limited to listings 235a, users 234a, etc.
Purchase History 238 accumulates as users purchase listings 235a-235n.
All Recorded Activities 231, such as purchasing or selling a Listing 235a, updating a Profile 234a, adding a listing or seller as a favorite are recorded in the Main Database 230.

The Main Processor 241 provides the capability to connect users together, and to indicate when users are available to connect because they have logged into the system. The Rules & Policies 242 control the availability of listings 235a-235n for purchase based on quantity levels and availability of users 232a-232n to contact. The System Administrator 240 is responsible for establishing, maintaining, and supporting the Main Processor 241 and Rules & Policies 242.

The Application Engine 243 provides the capabilities to support purchasing checkout process, communication between users 232a-232n, and aggregating data 245 such as purchases by specific connected users 232a-232n or sets of users 232a-232n. The user interface 244 displays the listings 235a-235n, profiles 234a-234n, and aggregated data 245.

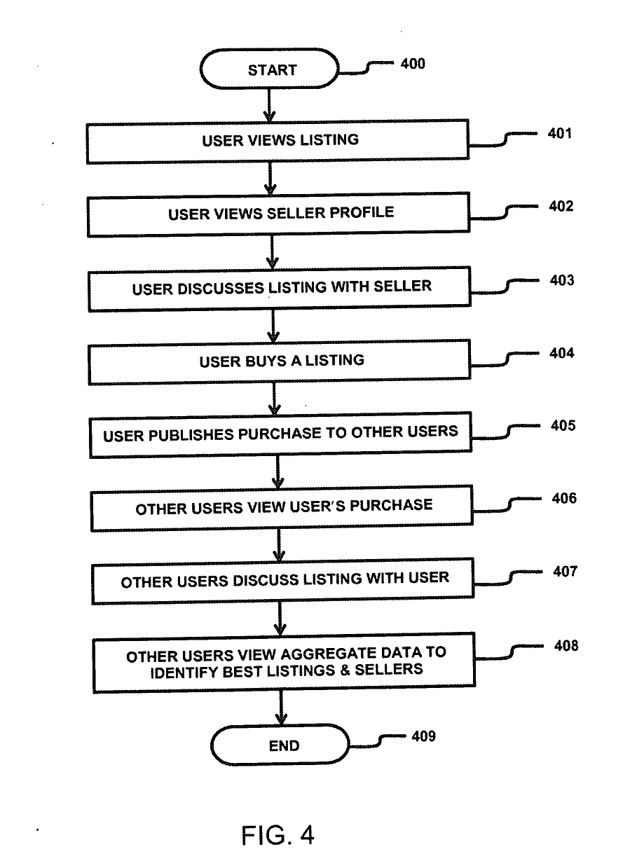

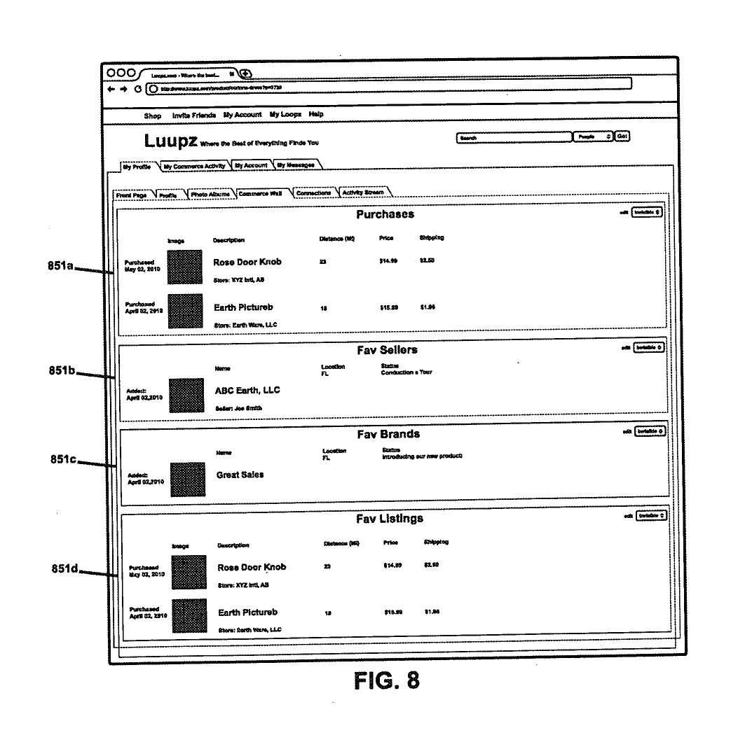

FIG. 4 is a flow diagram (flow chart) of an exemplary process including reviewing, discussing, and purchasing a product associated with a listing in accordance with an exemplary system supporting the disclosed subject matter. The process starts with step 400. In step 401, the user 232a views a listing 235a. In step 402, the user 232a views the seller's 232b profile 234a of the listing 235a to learn more about the seller 232b before purchasing. In step 103, the user 232a discusses the listing 235a, with the seller 232b via Collaborative Shopping user interface 701. In step 404, after both reviewing the listing 235a and the seller 232b, the user 232a purchases the listing 235a, which updates the purchase history 238 of the user 232a. In step 405, the user 232a publishes the purchase to other users 232c-232n so that they can view the purchase history 238 for that listing 235a. In step 406, the other users 232c-232n view the user's 232a purchase on the Commerce Wall page, 851a-851d, shown in FIG. 8. In step 407, at a later date other users 232c-232n contact the user 232a via the Collaborative Shopping user interface 701 to discuss the listing 235a to help them determine if they should purchase the listing 235a. In step 408, other users 232c-232n view aggregate data 245 of purchases that their connections 233a-233n have made in the past in order to help them determine the best listings 235a to buy and the best sellers 232a-232n from which to buy.

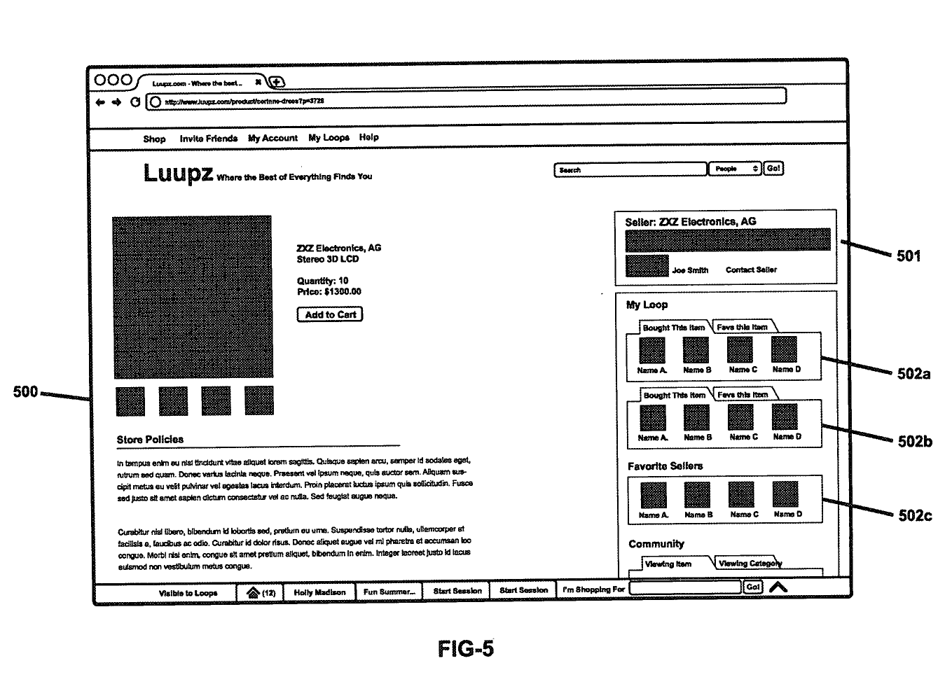

FIG. 5 is a diagram of a user interface, and more specifically a web page 500, in accordance with the system of the present disclosed subject matter showing listings. Listings 235a-235n can include any type of product, service, or transaction. This web page 500 includes information about the listing 235a. The web page 500 also includes information about the seller 232b in area 501. Along with other website pages, it provides information about users 232a-232n that have purchased the listings 235a based on purchase history 238 per user 232a-232n in 502a or selected the listing 235a or seller 232b as a favorite in areas 502a and 502b. The user 232a can use the information on this website page to help determine if the listing 235a meets his or her needs and is the listing 235a-235n that he or she should purchase. The listing 235a information in the web page 500 provides basic listing information such as what it is or does, price, quantity, etc. The seller 232b information in area 501 provides basic information about the seller such as his or her name, location, and a link to the seller's 232b profile 234b of detailed information.

Page sections 502a-502c provide insight into which of the user's 232a connections 233a-233n have some type of relationship to the listing 235 either by purchasing the listing 235a or selecting it as a favorite, or purchasing from the seller 232b or selecting the seller 232b as a favorite. The combination of this information provides more insight into whether the listing 235a meets the user's 232a needs based on the listing 235a detail as well as how popular the listing 235a is to users 232b-232n that the user 232a is connected to. This web page 500 also provides links to additional avenues of information, such as: Seller's 232b profile 234b, connections' 233a-233n profiles 234c-234n, communication with connections 233a-233n displayed in 502a-502c via the Collaborative Shopping user interface 701, and communication with the seller 232b via the Collaborative Shopping user interface 701.

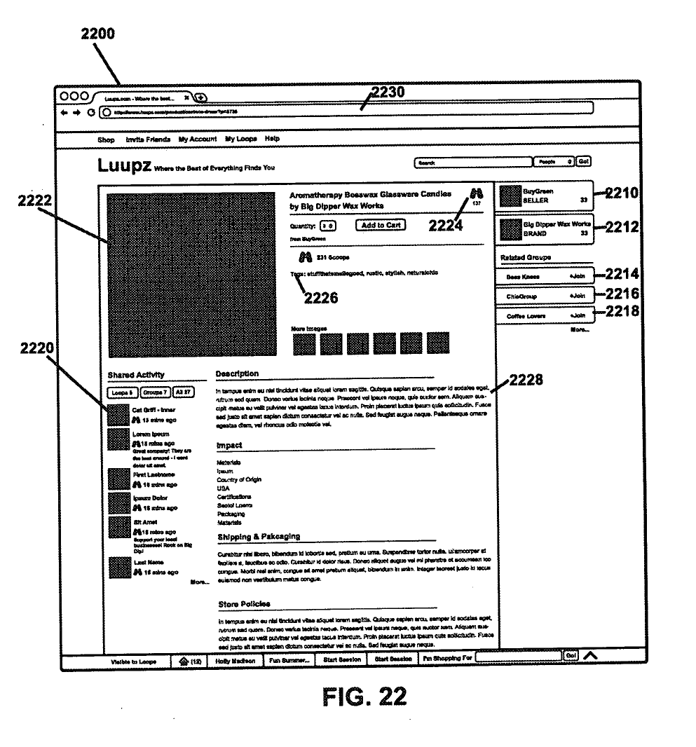

In an alternative embodiment, FIG. 22 is a diagram of a user interface showing a listing 235a, which in this example is “Aromatherapy Scents.” The user interface is a web page 2200. Section 2210 indicates that the particular seller 232b of the listing 235a is “BuyGreen.” Clicking on the seller's 232b name causes another web page to appear showing the seller's profile 234b. Section 2212 indicates the brand of the particular product shown in the listing 235a. In this illustrative example, the brand is “Big Dipper Wax Works.” Clicking on the name of the brand causes another web page to appear showing additional information about the brand. Items 2214, 2216, and 2218 are Groups 3034a-3034n relating to the listing 235b. Each of items 2214, 2216, and 2218 include a link which, when clicked on, allows the user to join the corresponding Group 3034a-3034n.

Section 2220 contains a display of recent activity from other users 232b-232n of the system. The display of activity can be filtered, using on/off toggles in this particular example, to include information from the user's 232b Loops 1634a-1634n, and/or Groups 3034a-3034n that the user has joined, and/or recent activity shared by all users 232b-232n of the system for any other user 232a-n of the system to view. Examples of shared activities which can be viewed in this section 2220 include items designated as favorites and product purchases. The web page 2200 includes an image 2222 of the product in the listing 235a and a textual description 2228 of the product in the listing 235a. Item 2224 shows the number of times that this particular listing 235a has been designated as a favorite by users of the system. Item 2224, if clicked on, allows the user viewing the web page to designate the listing as a favorite as well. Item 2226 lists textual tags associated with the listing. The tags assist in categorizing the listing 235a and aids in a user's 232a effort to search for a listing that may be of interest. Search box 2230 allows a user 232a to enter a textual search query based on the name of a listing 235a-235n, the name of a seller 232b-232n, a brand, tags, and/or other keywords. In yet further alternative embodiments, the search box includes a control to allow a user 232a to narrow a search to a particular type of entity, such as a user 232b-232n or a listing 235a-235n.

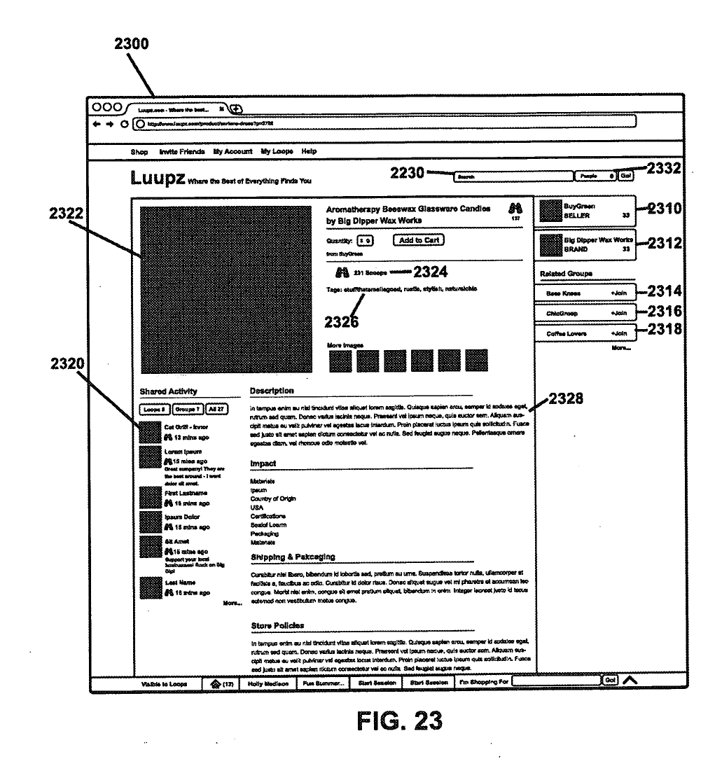

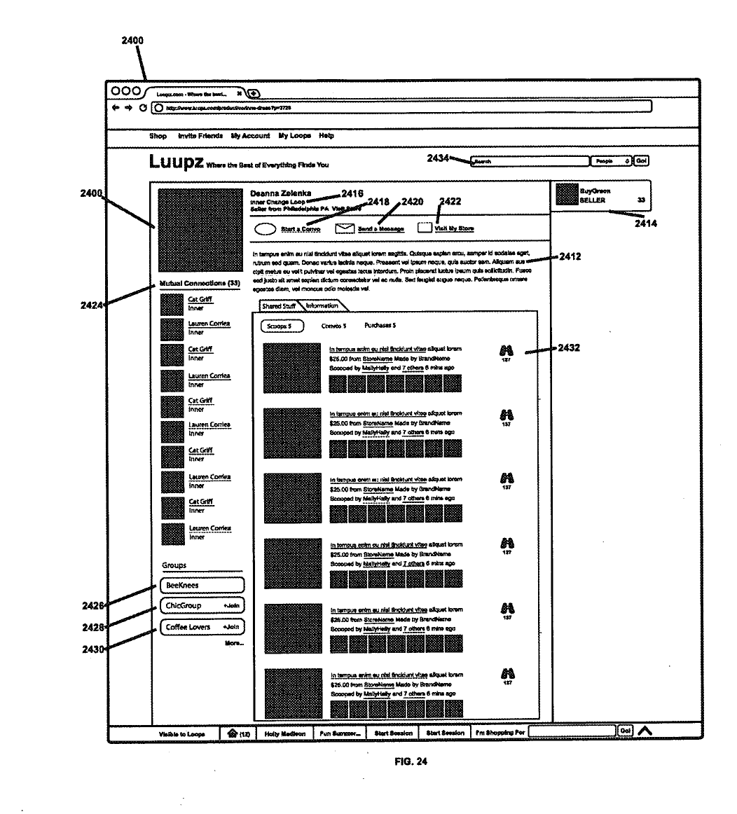

FIG. 23 is a diagram of a user interface showing a listing in accordance with yet another embodiment of a system in accordance with the present disclosed subject matter. In many ways, the user interface shown in FIG. 23 is similar to the user interface shown in FIG. 22. Again, the interface is a web page 2300. Section 2310 indicates the name of the seller 232b, which in this example is “Surf Products Inc.” Section 2312 indicates the brand. Both of sections 2310 and 2312 can be activated with a click to cause the system to display additional information about the seller 232b or brand, respectively. Sections 2314, 2316, and 2318 indicate Groups 3034a-3034n that relate to the type of product in the listing 235a. Each of sections 2314, 2316, and 2318 can be activated with a click to allow a user view extended information regarding the corresponding Group 3034a-3034n and/or join a Group 3034a-3034n. Section 2320 displays recent activity shared by users 232b-232n of the system, and operates in the same manner as section 2220 discussed above. An image 2322 of the dress associated with this listing 235a is displayed in the web page 2300.

Additionally, the number of times users 232b-232n have designated this listing 235a as a Favorite is shown at item 2324. Item 2324 can be activated with a click to allow a user 232a to designate the listing 235a as a Favorite as well. Tags 2326 associate the listing with keywords, which aid in searching for the listing 235a. A textual description 2328 of the product in the listing 235a also appears in the web page 2300. The search box 2330 allows a user to enter a textual search query for one of a category of entities, which can be chosen using the selector control 2332. For example, the user can search for other users 232b-232n of the system by selecting “People” in the selector control 2332. The user might instead choose another type of entity to search for, including but not limited to Groups 3034a-3034n or Listings 235a-235n.

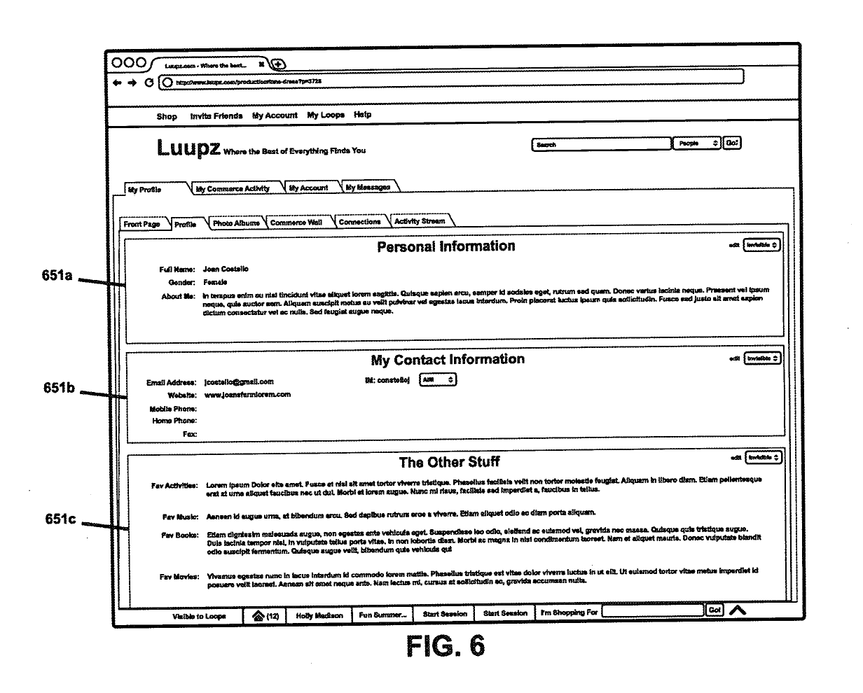

FIG. 6 is a diagram of a user interface, and more specifically a web page, in accordance with the system of the present disclosed subject matter showing a profile 234a, which supports the ability to provide detailed information about the user 232a-232n. Each user 232a-232n of the presently disclosed system has the option of creating a profile 234a-234n. There are many sections of profile 234a information, such as seen in sections 651a-651c. Users 232a-232n of the system can view profiles 234a-234n that they have access to as a method to learn more about the people they are communicating with, buying from, or selling to. The ability for a buyer 232a to learn more information about a seller 232b improves the user's 232a ability to judge whether he or she will purchase listings 235a-235n from the buyer 232b.

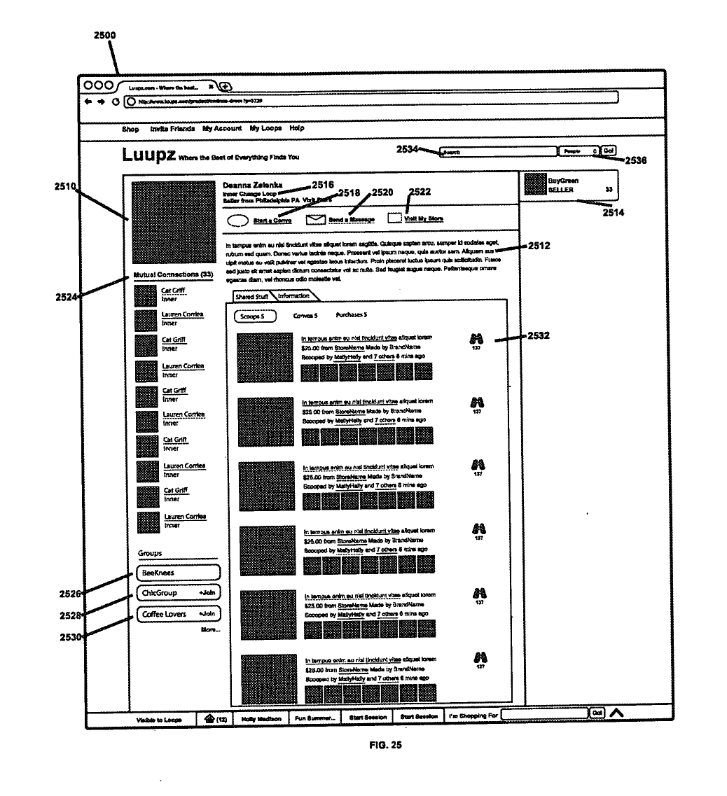

FIG. 24 is a diagram of a user interface showing a profile 234b in accordance with an alternative embodiment of a system in accordance with the present disclosed subject matter. The user interface is a web page 2400. The web page 2400 includes an image or avatar 2410 representing the user 232b whose profile 234b is displayed. A textual description 2412 of the user 232b also appears on the web page 2400. Section 2414 indicates that the user 232b is a seller of products and, in this particular example, uses the seller name of “BuyGreen”. Section 2416 indicates that the user 232b is associated with a Loop 1634a named “Inner” belonging to a user 232a viewing the web page 2400. Section 2416 also includes a link, which if clicked on, allows user 232a to move user 232b to a different Loop 1634b-1634n or no Loop at all. Section 2418, if clicked on, presents an interface for user 232a to conduct a conversation with user 232b. In this particular embodiment, conversations take place through text. However, in other embodiments, additional modes of communication may be utilized including images, audio, and/or video. Section 2420, if clicked on, allows user 232a to send a message to this user 232b. In this embodiment, the message is text-based. However, in alternative embodiments, the message may include text, images, audio, and/or video. Section 2422, if clicked on, results in the system presenting this user's store, allowing a user 232a to view and purchase products offered by this user 232b. Again, as discussed above, this user's 232b seller name is “BuyGreen”.

Additionally, in FIG. 24, section 2424 of web page 2400 displays connections that the user 232a viewing this profile 234b has in common with the user 232b whose profile 234b is being displayed. Sections 2426, 2428, and 2430 correspond to Groups 3034a-3034n associated with the user 232b whose profile 234b is being displayed. For each Group 3034a-3034n that the user 232a viewing the profile 234b is not already a member of, an option to join the Group 3034a-3034n appears, such as shown in sections 2428 and 2430. Section 2432 displays information that the user 232b has chosen to share with other users 232a, 232c-232n of the system. Search box 2434 allows a user 232a to enter a textual search query based on the name of a listing 235a-235n, the name of a seller 232b-232n, a brand, tags, and/or other keywords.

FIG. 25 is a diagram of a user interface showing a profile in accordance with yet another alternative embodiment of a system in accordance with the present disclosed subject matter. The user interface is a web page 2500. Many of the elements of this web page 2500 correspond with those of the user interface web page 2400 discussed with reference to FIG. 24. As with FIG. 24, the web page 2500 includes an image or avatar 2510 representing the user 232b whose profile is displayed. A textual description 2512 of the user 232b appears on the web page 2500. Section 2514 indicates that the user 232b is a seller of products and, in this particular example, uses the seller name of “Surf Products Inc.” Section 2516 indicates that the user 232b is associated with a Loop 1634a named “Inner” belonging to user 232a viewing the web page 2500. Section 2516 also includes a link, which if clicked on by user 232a, allows user 232a to move user 232b to a different Loop 1634b-1634n, or no Loop at all. Section 2518, if clicked on, presents an interface for user 232a to conduct a conversation with user 232b. In this particular embodiment, conversations take place through text. However, in other embodiments, additional modes of communication may be utilized including images, audio, and/or video. Section 2520, if clicked on, allows user 232a to send a message to this user 232b. In this embodiment, the message is text-based. However, in alternative embodiments, the message may include text, images, audio, and/or video. Section 2522, if clicked on, results in the system presenting this user's store, allowing a user 232a to view and purchase products offered by this user 232b.

Additionally, in FIG. 25, section 2524 of web page 2500 displays connections that the user 232a viewing this profile 234b has in common with the user 232b whose profile 234b is being displayed. Sections 2526, 2528, and 2530 correspond to Groups 3034a-3034n associated with the user 232b whose profile 234b is being displayed. For each Group 3034a-3034n that the user 232a viewing the profile 234b is not already a member of, an option, in the form of a link, to join the Group 3034a-3034n appears. This is shown in sections 2528 and 2530. Also, in each section 2526, 2528, and 2530 is a separate link to display further information regarding the corresponding Group 3034a-3034n. Section 2532 displays information that the user 232b has chosen to share with other users 232a, 232c-232n of the system. Search box 2534 allows a user 232a to enter a textual search query based on the name of a listing 235a-235n, the name of a seller 232b-232n, a brand, tags, and/or other keywords. Selector control 2536 allows user 232b to choose which type of entity to search for, among users 232a-232n, Groups 3034a-3034n, and Listings 1634a-1634n. Other types of entities might also be selectable from the selector control 2536 in other embodiments.

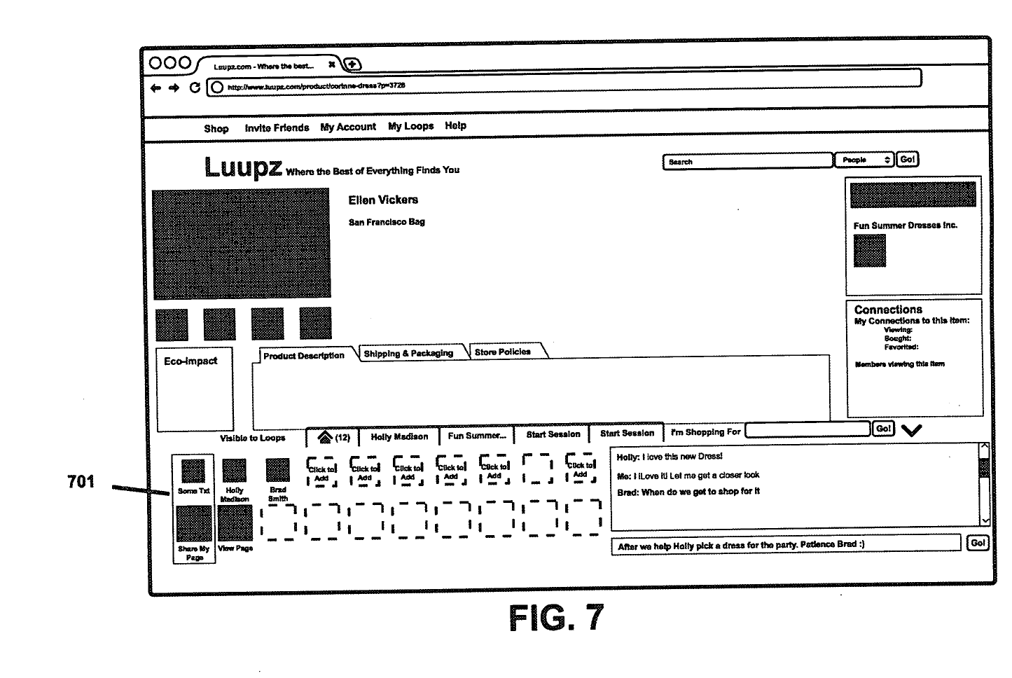

FIG. 7 is a diagram of a user interface for conducting Collaborative Shopping in accordance with the system of the present disclosed subject matter. In addition to viewing listing 235a-235n information and viewing seller 232b profile 234b information, the user 232a can contact the seller 232b and discuss the listing 235a via the Collaborative Shopping web page 701 shown in FIG. 7. This enables the user 232a to gain information that is not typically available in a static listing 235a page such as shown in FIG. 5. The Collaborative Shopping user interface 701 uniquely enables the user 232a to discuss the listing 235a with the seller 232b without leaving the website. Once the user 232a has decided to purchase the listing 235a, the user 232a can do so from the listing 235a web page 500 in FIG. 5. Doing so will update the user's 232a purchase history 238.

FIG. 8 is a diagram of a user interface, more specifically a web page, in accordance with the system of the present disclosed subject matter showing a Commerce Wall. Purchases can be optionally published by the user 232a so that other users 232b-232n can view selective purchase history 238 of the user 232a to aid in their decision making process. Published purchases can be viewed on the listing 35a page 500 in FIG. 5, areas 502a-502c, as well as on the Commerce Wall page in FIG. 8. The Commerce Wall page in FIG. 8 provides detailed information about purchases in area 851a, Favorite Sellers in area 851b, Favorite Brands in area 851c, and Favorite listings in area 851d if the user 232a chooses to publish that information.

Briefly revising FIG. 7, in addition to discussing a listing 235a with a seller 232b, the users 232c-232n can discuss the listing 235a with users 232a-232n that have purchased the listing 235a such as user 232a or have selected it as a favorite or have purchased from the seller 232b or have selected the seller 232b as a favorite. They can use the Collaborative Shopping user interface 701 in FIG. 7 to discuss the listing 235a with the user 232a to better understand how well the listing 235a met the user's 232a needs and how accurate the listings 235a page 500 (in FIG. 5) information and discussions with the seller 232b were. This provides users 232a-232n with a unique ability to judge whether the listing 235a truly meets their needs.

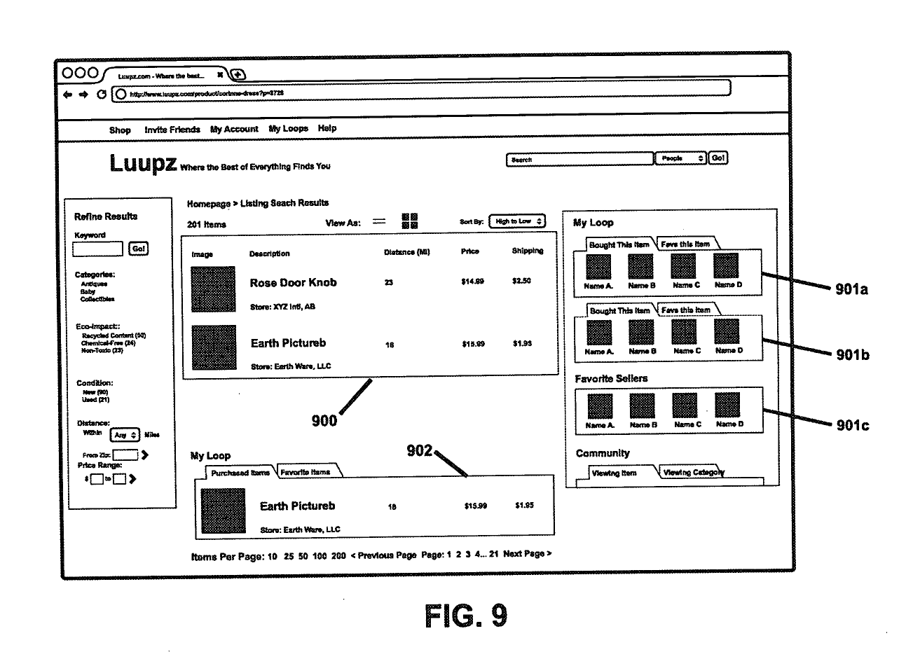

FIG. 9 shows a diagram of a user interface, more specifically a web page, in accordance with the system of the present disclosed subject matter showing search results. Users 232a-232n can view aggregate data 245 in user interfaces or web pages generated by the system of the present subject matter to help with purchase decisions. One example such a web page in shown in FIG. 9 is the listing 235a-235n search results. As with most search results, the user interface displays listings that meet the search criteria in area 900. Uniquely, the user interface also displays in 902 a narrowly focused set of listings that both meet the search criteria as well as have been purchased or selected as a favorite by the user's 232a connections 233a-233n. This enables the user 232a to focus on listings 235a that trusted connections 233a-233n valued, which increased the likelihood that the listing 235a will meet the user's 232a needs. In addition, the user interface in FIG. 9 also displays connections 233a-233n in 901a-901c that have purchased any of the listings 235a-235n in the search results or set any of them as a favorite or purchased from a seller 232a-232n of any of the search results or set any of the sellers 232a-232n of the search results as a favorite. Like similar functionality of sections 502a-502c in the listing 235a page 500 of FIG. 5, these connections 233a-233n can be contacted via the Collaborative Shopping user interface 701 to discuss the listings in detail to help with the purchase decision-making process.

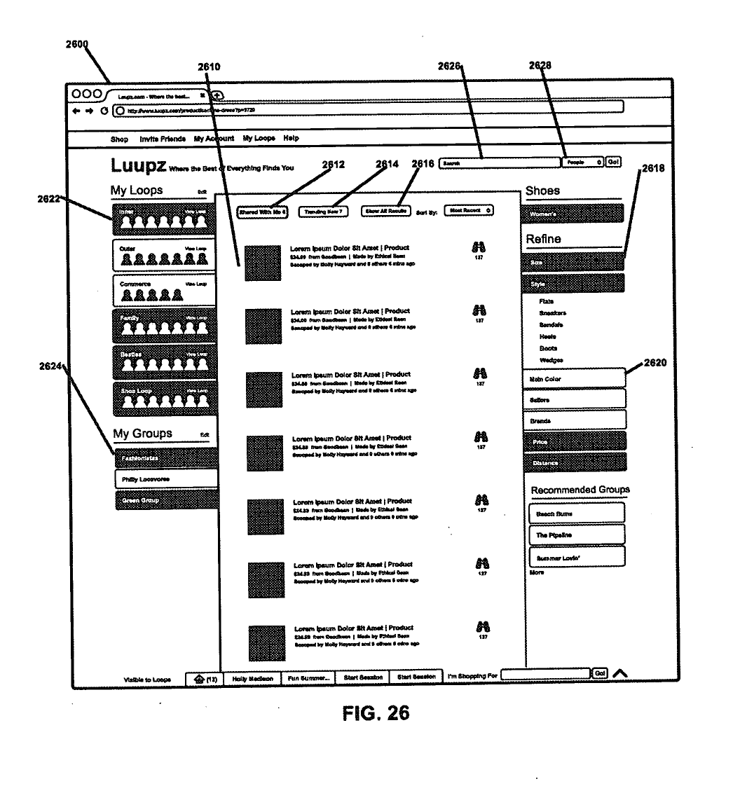

FIG. 26 is a diagram of a user interface showing search results in accordance with an alternative system in accordance with the present disclosed subject matter. The user interface is a web page 2600. Key differences in this alternative embodiment are that a user 232a is able to refine search results through a variety of user interface controls. In this particular example, the user 232a has searched for shoes, as reflected in the search box 2626, which shows “shoes” and selector control 2628, which is set to “Products”. The search results appear in area 2610, with images of shoes, descriptions of the shoes and their corresponding prices, brands, and sellers. Also visible are the number of times each product listing 235a-235n appearing in the search results 2610 has been indicated as a favorite by users 232a-232n. Across the top of the search results 2610 are a set of toggles or controls, which allow a user 232a to refine the search.

Toggle 2612 allows a user 232a to limit the search results to listings 235a-235n that have been shared with the user 232a. Toggle 2614, which in this particular example is labeled “Shared With Me” refines the search results to listings 235a-235n that users 232a-232n have publicly shared the most. In this particular example, toggle 2614 is labeled “Trending Now”. Toggle 2616, which in this example is labeled “Show All Results”, shows results from the search without either of the previously discussed refinements to the set of results. Section 2618 contains additional controls for further defining the particular type of product being searched for. In this example, given that the keyword searched for is “shoes”, section 2618 includes toggles for specifying particular styles, colors, and sizes. Also in this section are controls for limiting the search results to particular brands, sellers, and price range. Section 2620 lists Groups 3034a-3034n pertaining to the listings 235a-235n appearing in the search results 2610, with links for joining and/or viewing additional information for each Group 3034a-3034n.

Still referring to FIG. 26, section 2622 displays the Loops 1634a-1634n that the user 232a viewing this particular web page 2600 maintains. The user 232a can select one or more such Loops 1634a-1634n to limit the search results to those shared by users 232b-232n in those Loops 1634a-1634n. Likewise, section 2624 lists Groups 3034a-3034n that the user 232a is a member of and, by selecting one or more of the Groups 3034a-3034n, the user 232a can limit the search results to listings shared by users 232b-232n in those Groups 3034a-3034n. Search results do not return avatars for Connections 233a-233n who have shared items related to search results. However, these avatars do appear on store, brand and product/listing pages.

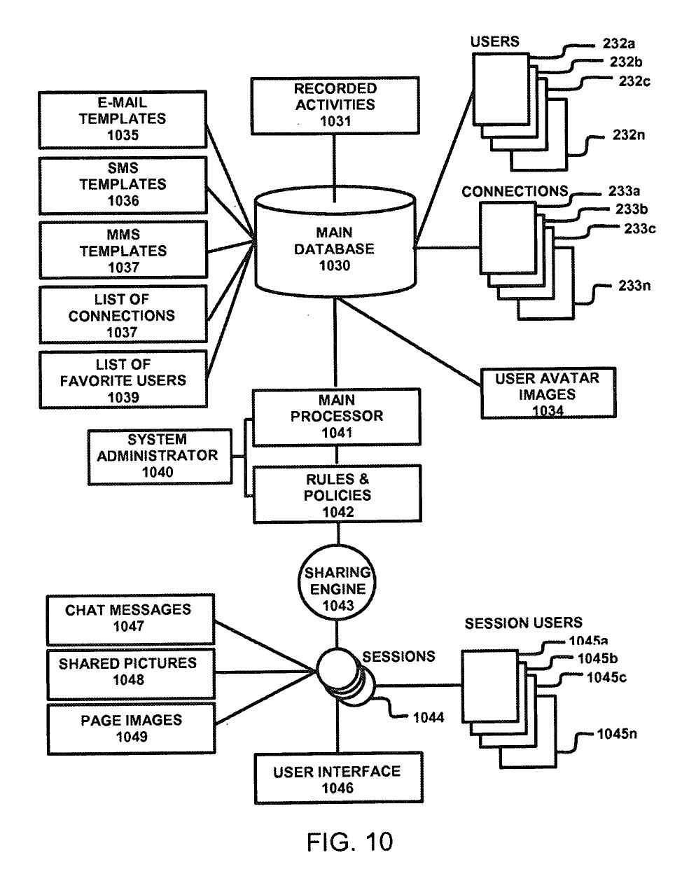

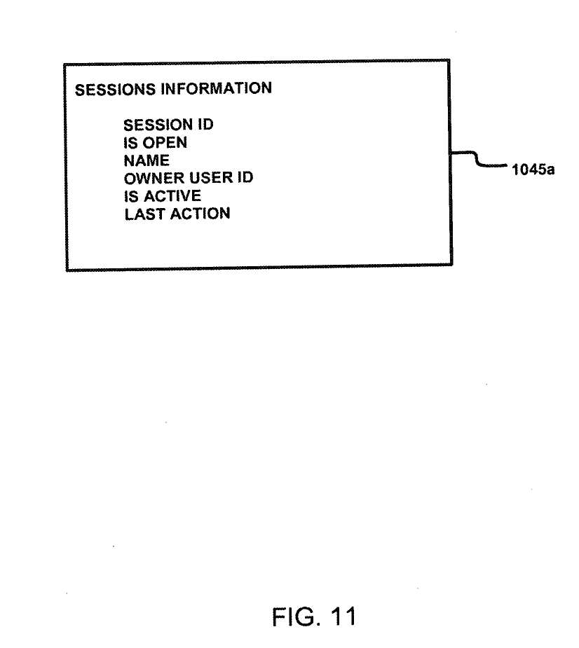

Focusing now on the collaborative shopping functionality of the present disclosed subject matter, FIG. 10 is a diagram focusing on the transfer, storage, and processing of data in an exemplary system supporting the disclosed subject matter. FIG. 11 is a diagram of an exemplary database entry for storing information about collaborative shopping sessions in an exemplary system supporting the disclosed subject matter. The Main Database 1030 stores all data or references to external data, for example, images. The following types of data are managed by the Main Database 1030:
User Records 232a-232n, shown in FIG. 3A: When a user registers with the system 100, the system 100 generates a User record 232a-232n including a User ID generated by the system 100 as a unique identifier for the user, First Name, Last Name, Company Name, Username as selected by the user, Password, and Email Address of the user.
Each time one user establishes a connection with another user, the system 100 generates a Connection record 233a-233n, shown in FIG. 3B, which includes a Connection ID generated by the system 100, the Owner User ID of the user initiating the connection, To User ID of the user receiving the connection request, Connection Type to indicate how the connection was made, and Circle ID to indicate the privacy setting of the connection.
Avatar Images 1034 are stored in an external Image System 1014.
E-Mail 1035, SMS 1036, and MMS 1037 templates are stored for communication between users during the process of establishing a collaborative shopping session.
Lists of Connections 1038 and List of Favorite Users 1039 are stored to be later presented on the Collaborative Shopping Home Page.
All Recorded Activities 1031, such as inviting a user to a collaborative shopping session, accepting an invitation, or rejecting an invitation.

The Main Processor 1041 provides the capability to connect users together, and to indicate when users are available to connect because they have logged into the collaborative shopping home page.

The Rules & Policies 1042 control the visibility and privacy of a user as viewed by other users that have established a connection or been selected as a favorite by the user. This control is based on the user's privacy setting. Rules & Policies 1042 also determine what functions are supported in an Open or Closed session. The System Administrator 1040 is responsible for establishing, maintaining, and supporting the Main Processor 1041 and Rules & Policies 1042.

The Sharing Engine 1043 provides the capabilities to support Chat messages and Shared Pages being displayed to all users of a session. Each Shared Session 1044 is a distinct entity on the system and supports:
Individual Chat Messages 1047 sent from a user to all users in a session
A single Shared Page 1048 sent from a user to all users in a session
A Page Image 1049 that corresponds to the shared page sent by a user to all users in a session
A visual reference in the form of an Avatar Image 1034 of all Session Users 1045a-1045n. Session information is stored as shown in FIG. 11. Session information stored and tracked by the system 100 includes the Session ID generated by the system, IS Open flag to indicate if the session is open or closed, Name of the session, Owner User ID to indicate which user started or owns the session, Is Active to indicate if the session is active, and Last Action of each session.
The User Interface 1046 combines all visual elements, including the Chat Message(s) 1047, Shared Page(s) 1048, Page Image(s) 1049, and User Avatar(s) 1034 into one tabbed panel.

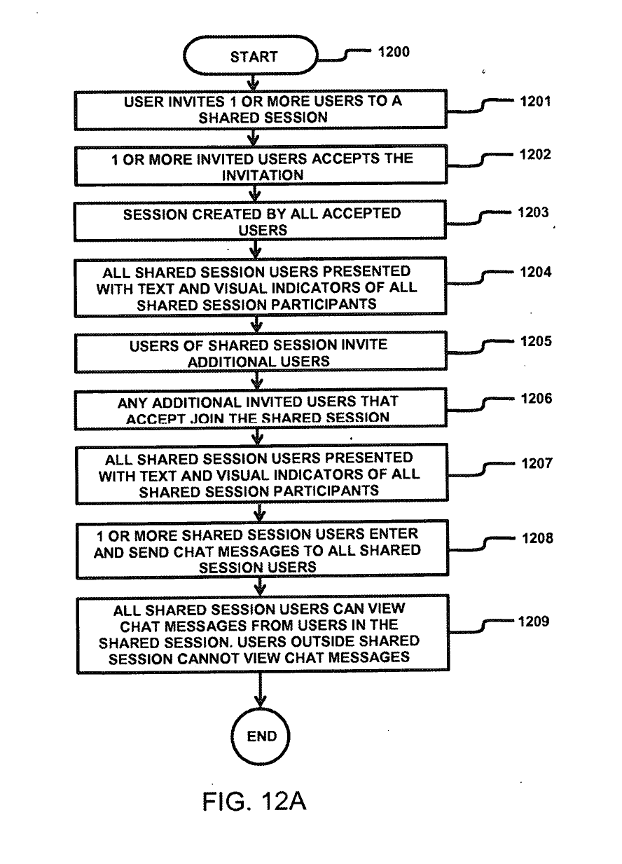

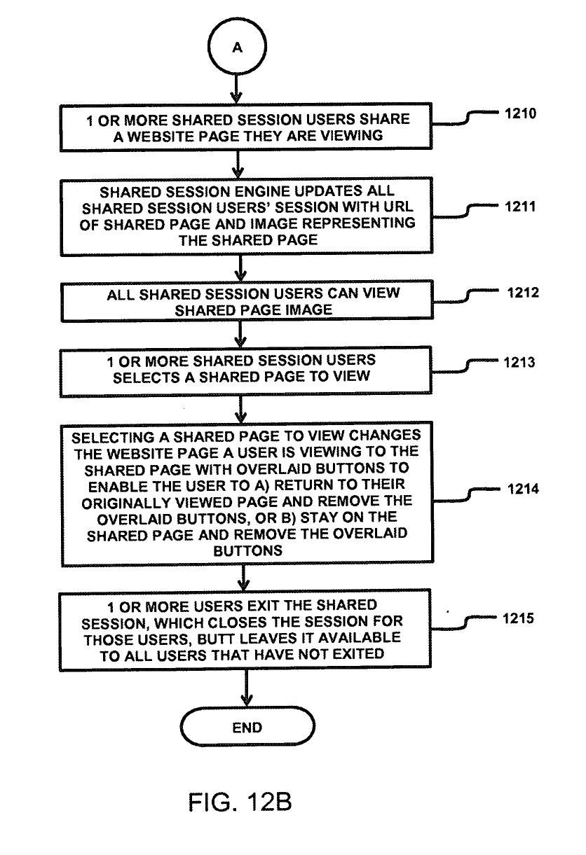

FIGS. 12A through 12B are flow diagrams (flow charts) of an exemplary process of conducting a collaborative shopping session in an exemplary system supporting the disclosed subject matter. The process starts with step 1200. In step 1201, a user 232a invites one or more other users 232a that the user has a connection 233a with to a shared session 1044 via email 1035, SMS 1036, or MMS 1037. Information regarding such users is stored in the list of connections 1038 and the list of favorite users 1039. The list of connections 1038 and list of favorite users 1039 is determined by the Rules & Policies 1042 as processed by the Main Processor 1041 and configured by the System Administrator 1040. In step 1202, one or more users 232a accept an invitation from another user 232a, which in step 1203 creates a session user record 1045a for each participant and records this activity 1031 to be stored in the main database 1030 and displayed in the user interface 1046 in the Activity panel 1425.

In step 1204, all shared session 1044 users' 232a user interfaces 1046 are updated to display each participant's avatar 1034 and page image 1049 which represents the user's 232a optional shared page 1048, per processing by the Sharing Engine 1043. In step 1205, users 232a optionally invite additional users 232a. In step 1206, invited users 232a, accept invitations and create additional session users 1045a for the session 1046. In step 1207, if users 232a accept invitations, user interfaces 1046 are updated for each session user 1045a. In step 1208, one or more users 232a optionally send chat messages 1047 to the other session users 1045a. In step 1209, only the session users 1045a of the session 1044, can view the chat messages 1047 as controlled by the sharing engine 1043. In step 1210, one or more session users 1045a share a page 1048 they are viewing. In step 1211, the Sharing Engine 1043, updates all session users 1045a session 1044, with the URL of the shared page 1048, and a page image 1049 that represents the page visually. In step 1212, session users 1045a can select the shared page 1048 of other session users 1045a. In step 1213, one or more session users 1045a select a shared page 1048 to view, which in step 1214, updates the user's 232a user interface 1046 to the website page of the shared page 1048. The user's 232a user interface 1046 provides the option to return to their previous website page or select the shared page 1048 as the user's 232a new website page. In step 1215, one or more session users 1045a exit the session 1044, which closes the session 1044 for those users 232a, but leaves the session 1044 available to remaining session users 1045a. If all session users 1045a exit the session 1044, the session 1044 will be closed on the system.

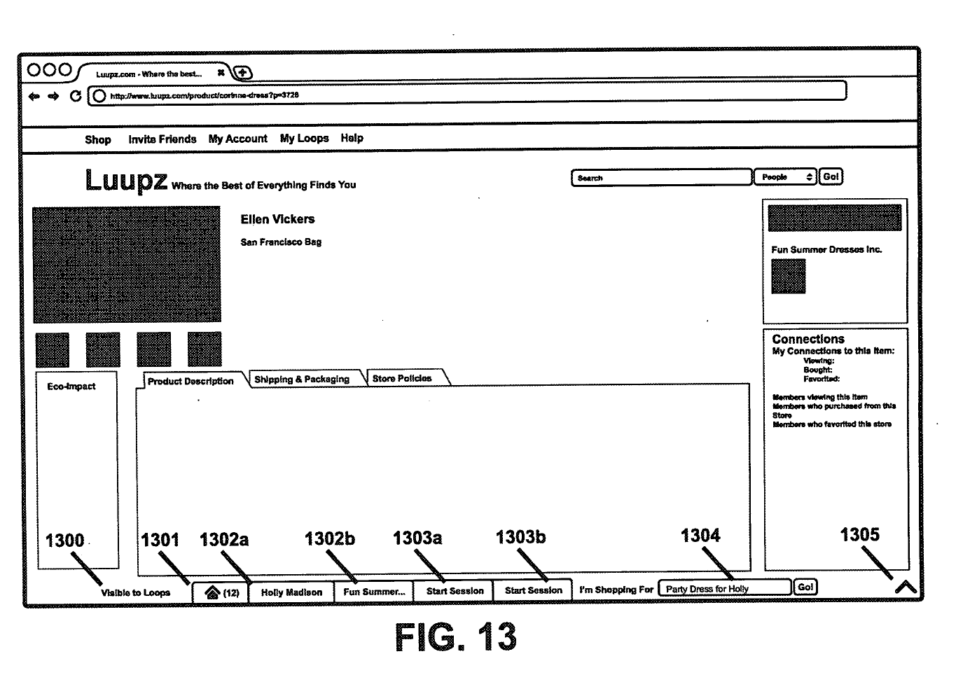

### System Screens Overview—FIGS. 13-15

A key element of the system and user interface 1046 across all pages is the Collaborative Shopping Panel. This can be described as or thought of as a HUD (Heads Up Display) or user interface for the user 232a to find and interact with fellow system users 232a. The collaborative shopping panel will be positioned at the bottom of the browser window in a layer on top of the actual window. Collaborative shopping on the system is a real time interaction (one to one, one to many, or many to many) of users 232a to learn, explore, share, and socialize around the system marketplace, its products, ideas, and trends. Collaborative shopping on the system will allow users 232a to interact online while shopping and exploring the system platform.

A collaborative shopping session 1044 allows a user 232a to interact with one or more other users 232a in a shared shopping or social experience. The members of these sessions 1044, called session users 1045a, can:
Send/Receive chat messages 1047 to the session users 1045a via the chat window 1553
Share Pages 1048 with the session users 1045a via the share pages hyperlinks 1552a
View Pages of other session users 1045a via the view page hyperlinks 1552b, 1552c

### Open/Closed Sessions

Additionally, the sessions 1044 can be open or closed as set by the lock button 1550. If open, any session user 1045a can invite other users to participate. If closed, only the initiator of the session can invite other users to join the session. In an open session 1044, the initiator of the session 1044 is not asked to approve people invited to the session 1044 by other session users 1045a. As a new user 232a is joining the session 1044, all session users 1045a should have some indicator (such as the avatar image 1034 changing to “jsmith is joining”) that a new user 232a is joining the session 1044. All new sessions 1044 default to a closed session 1044.

### Ending Open/Closed Sessions

If an initiator ends a session 1044 the impact varies based on whether the session 1044 is open or closed. If open, the session 1044 continues for all remaining session users 1045a. To simplify this, once a session 1044 is set to open, the lock button 1550 is disabled and the session 1044 cannot be closed again. If a session 1044 is closed and the initiator ends the session 1044, the session 1044 will end for all session users 1045a as well.

### Collaborative Shopping Displays

The collaborative shopping displays are composed of two elements:

Collaborative shopping bar (shown in FIG. 13)

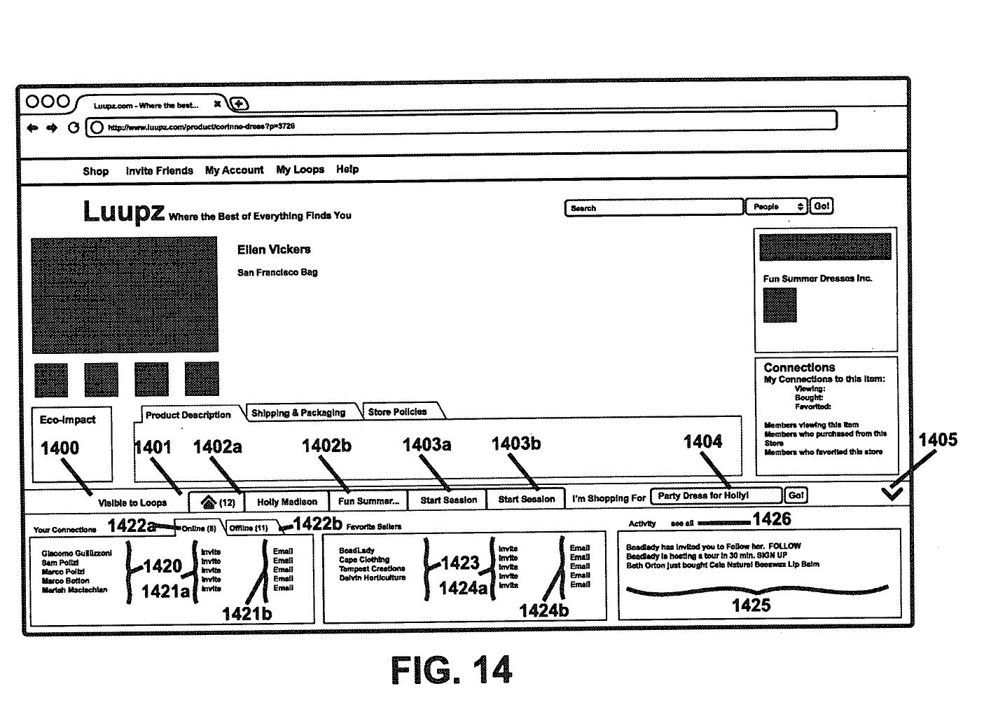

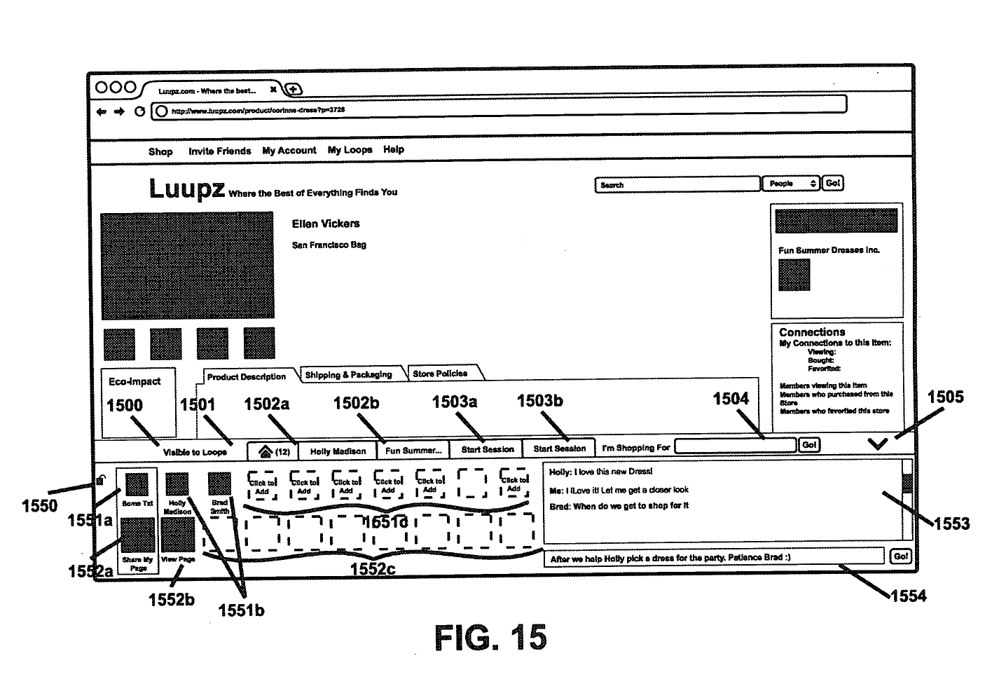

Collaborative Shopping Body
Collaborative Shopping Home page (shown in FIG. 14)
Collaborative Shopping Session page (shown in FIG. 15)

### Collaborative Shopping Bar—FIG. 13

The Collaborative Shopping Bar (shown in FIG. 13) is always shown on every page and cannot be removed or turned off. The Collaborative Shopping Bar (FIG. 13) provides the following information at all times:

User's 232a availability (Invisible, Visible to Loops, Visible to All) as indicated by the availability dropdown 1300.

Collaborative Shopping Home tab 1301. This tab displays the Collaborative Shopping Body and switches the Collaborative Shopping Body to the collaborative shopping Home page (FIG. 14).

Collaborative Shopping Session tabs 1302a, 1302b, 1303a, 1303b. These tabs display the Collaborative Shopping Body and switches the Collaborative Shopping Body to the specific collaborative shopping session 1044 that was selected, if one exists. If the user 232a selects a “Start Session” tab 1303a, it opens the invitation pop-ups to create a new session 1044. Each session 1044 is represented by the collaborative shopping Session page (FIG. 15).

Shopping Status, represented by “I'm shopping for” 1304.

Full/Compact arrow 1305. If the collaborative shopping display is in compact view, clicking this arrow 1305 displays the Collaborative Shopping Body. If in full view it removes the Collaborative Shopping Body. The arrow 1305 will point down when in full view, and point up when in compact view. The collaborative shopping layer should start in compact view as set by the full/compact arrow button 1305. Any changes from compact to full to compact, etc. should be stored so that the user 232a is returned to compact or full based on where it was the last time the user 232a was signed-in.

### Collaborative Shopping Home Page—FIG. 14

The Collaborative Shopping Home Page (FIG. 14) provides a user interface (webpage) for a user 232a to invite his or her connections 1420 via the invite hyperlinks 1421a and/or favorite users 1423 via the invite hyperlinks 1424a to a collaborative shopping session 1044. A total count of online connections 1422a and offline connections 1422b is available. The user 232a can also view published activities provided by their connections 233a in the Activity window 1425. The user 232a can view all Activities be selecting the see all hyperlink 1426.

### Collaborative Shopping Session Page—FIG. 15

The collaborative shopping Session page (FIG. 15) provides a user interface (webpage) for users 232a to interact with each other via a chat window 1553 and shared pages 1552a-1552c. Each user 232a can send chat messages 1047 and shared pages 1048, or only send chat messages 1047, or only send shared pages 1048. The session user 1045a decides which if any he or she sends. An individual session user 1045a does not automatically share his or her page. Instead he or she must click the “Share My Page” hyperlink 1552a to push his or her page to the other session users 1045a. Each time he or she clicks the “Share My Page” hyperlink 1552a, the user's 232a current page is pushed to the session users 1045a and the page images 1552b, 1552c are updated to reflect the new page. The chat messages 1047 and shared pages 1048 in one session 1044 are only available to session users 1045a of that session 1044. The user 232a is included in all sessions 1044 visible to him or her as session tabs 1502a, 1502b, 1503a, 1503b, but the pages they share 1048 are unique to each session 1044. This allows the user 232a to share different pages 1048 to different sets of users 232a at the same time. Also, the session users 1045a of a session 1044 can be included in one or more sessions 1044 with or without the same user 232a or users 232a, though they will have to be invited to each individually. There are no restrictions to prevent a user 232a from inviting the exact same users 232a to all session tabs 1502a, 1502b, 1503a, 1503b, that he or she can see in his or her user interface 1046.

### System Screens Detail—FIGS. 13-15

### Collaborative Shopping Bar—FIG. 13

The collaborative Shopping Bar (FIG. 13) is always shown on every page and cannot be removed or turned off. The Collaborative Shopping Bar (FIG. 13) provides the following information at all times:

User's 232a availability (Invisible, Visible to Circles, Visible to All) as indicated by the availability dropdown 1300.

Collaborative Shopping Home tab 1301. This tab displays the Collaborative Shopping Body and switches the Collaborative Shopping Body to the Collaborative Shopping Home page (FIG. 14).

Collaborative Shopping Session tabs 1302a, 1302b, 1303a, 1303b. These tabs display the Collaborative Shopping Body and switches the Collaborative Shopping Body to the specific collaborative shopping session (FIG. 15) that was selected, if one exists. If the user 232a selects a “Start Session” tab 1303a, 1303b, it opens the invitation pop-ups to create a new session 1044. Each session 1044 is represented by the collaborative shopping Session page (FIG. 15).

Shopping Status, represented by “I'm shopping for” 1304.

Full/Compact arrow 1305. If the collaborative shopping display is in compact view, clicking this arrow 1305 displays the Collaborative Shopping Body. If in full view it removes the Collaborative Shopping Body. The arrow 1305 will point down when in full view, and point up when in compact view. The collaborative shopping layer should start in compact view as set by the full/compact arrow button 1305. Any changes from compact to full to compact, etc. should be stored so that the user 232a is returned to compact or full based on where it was the last time they were signed-in.

### User's Availability Indicator and Selection

The Availability Indicator 1300 provides a colored dot and text to indicate the user's 232a current Availability setting. The user 232a can use the dropdown to select a different state of Availability. When a user 232a appears online to other users 232a, those other users 232a will see a green dot next to the user's 232a name and they will be able to invite the user 232a to a collaborative shopping session (FIG. 15). If they are invisible to that user 232a, the user 232a will see a gray dot next to the user's 232a name.

### Collaborative Shopping Home Tab/Connections Online Count

The Home tab 1301 displays the Collaborative Shopping Body and switches the Collaborative Shopping Body to the collaborative shopping Home page (FIG. 14). The number in parentheses next to the Home tab 1301 icon is the Connections 233a Online Count. The Connections 233a Online Count displays a current count of the number of Connections 233a that are currently online. The Connections 233a Online Count should change automatically as users 232a come online or offline.

### Collaborative Shopping Session Tabs

These tabs 1302a, 1302b, 1303a, 1303b display the Collaborative Shopping Body and switches the Collaborative Shopping Body to the specific collaborative shopping session (FIG. 15) that was selected, if one exists.

There are two types of tabs
Active session tab 1302a, 1302b
Start a Session tab 1303a, 1303b

An active session tab 1302a, 1302b is represented by the name of the session 1044. Selecting an active tab 1302a, 1302b displays the collaborative shopping Session page for that session 1044. A start session tab 1303a, 1303b is represented by “Start Session” as the tab title. If selected the invitation pop-ups to create a new session 1044 are displayed. The session tabs 1302a, 1302b, 1303a, 1303b are organized by the order in which they are created with all empty session(s), if any, to the right of active sessions. The older active sessions are placed to the left of newer active sessions.

### Shopping Status

The Shopping Status 1304 input field allows the user 232a to indicate what he or she is currently shopping for within the system. Whatever message the user 232a provides in this field will be available to other users 232a when they mouse-over/hover that user's avatar image 1034. The user's 232a message should insert “I'm Shopping for” before his or her message. If for example, a user 232a enters “summer dresses”, when any other user 232b hovers over the user's 232a avatar image 1034 he or she should see “I'm Shopping for summer dresses”. The avatar image 1034 can appear through the system screens. In all cases, if a user 232b hovers over that avatar image 1034, he or she will see the Shopping Status message 204 created by the user 232a.

### Full/Compact Arrow

If the collaborative shopping display is in compact view, clicking this full/compact arrow 1305 displays the Collaborative Shopping Body. If in full view it removes the Collaborative Shopping Body. The full/compact arrow 1305 will point down when in full view, and point up when in compact view.

### Notifications

Key events should be displayed within the Collaborative Shopping Bar (FIG. 13). These events include:
Notice of invitations accepted per session 1044 (regardless of whether invitation sent by user 232a or in case of open session 1044, by another session user 1045a)
Notice of session user 1045a leaving a session 1044, per session 1044
Notices of new pages shared 1048 per session 1044
Notices of new chat messages 1047 per session 1044
Notices of invitation requests
Notices of closed session 1044 ended by session 1044 intiator

Notices should appear as bubble text that is localized over the session tabs 1302a, 1302b, 1303a, 1303b so that a notice is placed above the session tab 1302a, 1302b, 1303a, 1303b it relates to. These messages should include one of the following, depending on the notice type, where Invitation accepted: “<USERID>” is the user identification (userID) of the session user 1045a that initiated the notice:
New chat message 1047: Total number of unread chats+Content of the first new chat message 1047
Invitation accepted: Person icon+“<USERID> joined session 1044”
Member leaving session: Person icon+“<USERID> has left the session 1044”
New page(s) shared: Page icon+“<USERID> has shared new page 1048”

The new chat message 1047 notices should persist until the user 232a clicks the session tab 1302a, 1302b, 1303a, 1303b of the session 1044 with notices. The other notice types (Invitation accepted, Member leaving session, and new page shared) should fade away after 30 seconds.

For Invitation Request notifications, a different type of notification is used, which is a pop-over that covers the entire Collaborative Shopping Bar (FIG. 13).

When a closed session 1044 is ended by its initiator it ends for all session users 1045a. When ended, the session 1044 should be changed from active to inactive, and the session tab's 1302a, 1302b, 1303a, 1303b title should change to “Session Closed”. After 1 minute, this title should change to an inactive tab with a title of “Start Session”. Regardless of its title, when an inactive tab 1303a, 1303b is selected the process is the same, the invitation process is started.

Notifications in Compact vs. Full View

While in Compact View, notifications should appear as described under Notifications above. However, when in Full View, if the Session Page (FIG. 15) is displayed (as apposed to the Home page FIG. 14), notifications should not appear over the session tab 1302a, 1302b, 1303a, 1303b for the active session 1302a, 1302b that is currently displayed. However, notifications should appear as described under Notifications above, for active sessions 1302a, 1302b that are not currently visible, for any reason.

### Collaborative Shopping Home Page—FIG. 14

The collaborative shopping Home page (FIG. 14) provides a page for a user 232a to invite his or her connections 233a and/or favorite users 1039 to a collaborative shopping session (FIG. 15). The user 232a can also view published activities 1425 provided by his or her connections 233a. The Collaborative Shopping Home page (FIG. 14) is displayed on every page as an overlay to the user's 232a current page. The Collaborative Shopping Home page (FIG. 14) can be accessed from the following collaborative shopping pages:

Expanded below the Collaborative Shopping Bar (FIG. 13) if in compact view and Home tab 1401 selected.

The Collaborative Shopping Session page (FIG. 15), if the user 232a selects the Home tab 1401.

If a user 232a is registered and signed-in the Collaborative Shopping Home page (FIG. 14) will be displayed. The Collaborative Shopping Home page (FIG. 14) has the following screen elements:

Your Connections Section 1420, 1421a, 1421b, 1422a, 1422b

Favorite Sellers/Stores Online Section 1423, 1424a, 1424b

Activity Section 1425, 1426

### Your Connections Section

If the user 232a is new to the system and has not yet created any connections 233a with other system users 232a, the Collaborative Shopping Home page (FIG. 14) Your Connections section 1420, 1421a, 1421b, 1422a, 1422b is empty and displays a message about why the section is empty as well as a button to invite connections 233a.

If the user 232a does have connections 233a with other system users 232a, the Collaborative Shopping Home page (FIG. 14) Your Connections section 1420, 1421a, 1421b, 1422a, 1422b will display a list of connections 1038 that are online and offline. Any online connections 233a can be invited to a collaborative shopping session (FIG. 15) by selecting the Invite hyperlinks 1421a. A user can also send an email 1035 to a Connection (whether online or offline) by selecting the Email hyperlink 1421b. Selecting the Email hyperlink 1421b will open the user's standard email client. The Connections 233a available should change automatically as users 232a come online or offline.

### Favorite Sellers/Stores Online Section

If the user 232a has not selected any users 232a as favorites 1039, the Collaborative Shopping Home page (FIG. 14) Favorite Sellers/Stores Online section 1423, 1424a, 1424b will be empty and will display a message explaining why it is empty.

If the user 232a has selected Sellers/Stores as favorites 1439 at some point, the Collaborative Shopping Home page (FIG. 14) Favorite Sellers/Stores Online section 1423, 1424a, 1424b will display a list of favorite Sellers/Stores 1039 that are currently online as well as an Invite link 1424a, which can be used to invite the Seller to a collaborative shopping session (FIG. 15). A user 232a can also send an email 1035 to a Seller by selecting the Email hyperlink 1424b. Selecting the Email hyperlink 1424b will open the user's 232a standard email client. The Favorite Sellers available should change automatically as users 232a come online or offline.

### Activity Section

If the user 232a has no Activity, the Collaborative Shopping Home Page (FIG. 14) Activity section 1425, 1426 will be empty and display a message as to why it is empty. If there is activity, the activity messages 1425 will be displayed in this section 1425. Messages include:

Changes to connection's “I am Shopping For . . . ” (1st Degree Connections only)

Announcements of Tours by Favorite Sellers

Published Purchases by 1st Degree Connections

Pages Shared by Session users 1045a

Users 232a joining a session 1044

Users 232a leaving a session 1044

Invitations sent to the user 232a

Activity information should be persistent across sessions 1044. A user 232a should be able to view all history that has been pushed to the user 232a by selecting the see all hyperlink 1426.

### Collaborative Shopping Session Page—FIG. 15

The collaborative shopping Session page (FIG. 15) provides a page for users 232a to interact with each other via a chat window 1553 and shared pages 1552a-1552c. Each user 232a can send chat messages 1047 and shared pages 1048, or only send chat message 1047, or only send shared pages 1048. The session user 1045a decides which if any he or she sends. An individual session user 1045a does not automatically share his or her page. Instead, he or she must click the “Share My Page” hyperlink 1552a to push his or her page to the other session users 1045a. Each time the user 232a clicks the “Share My Page” hyperlink 1552a, the user's 232a current page is pushed to the session users 1045a and the page images 1552b, 1552c are updated to reflect the new page. The chat messages 1047 and shared pages 1048 in one session 1044 are only available to session users 1045a of that session 1044. The user 232a is included in all sessions 1044 visible to him or her as session tabs 1502a, 1502b, 1503a, 1503b, but the pages they share 1048 are unique to each session 1044. This allows the user 232a to share different pages 1048 to different sets of users 232a at the same time. Also, the session users 1045a of a session 1044 can be included in one or more sessions 1044 with or without the same user 232a or users 232a, though they will have to be invited to each individually. There are no restrictions to prevent a user 232a from inviting the exact same users 232a to all session tabs 1502a, 1502b, 1503a, 1503b, that they can see in their user interface 1046.

The Collaborative Shopping Session page (FIG. 15) is displayed on every page as an overlay to the user's 232a current page. The Collaborative Shopping Session page (FIG. 15) can be accessed from the following collaborative shopping pages:
Expanded below the Collaborative Shopping Bar (FIG. 13) if in compact view and active session tab 1502a, 1502b, 1503a, 1503b selected. (See collaborative shopping Displays for more information about the collaborative shopping bar).
The Collaborative Shopping Home page (FIG. 14), if the user 232a selects an active session tab 1502a, 1502b, 1503a, 1503b.
Displayed at the end of the Invitation Page.
   The Collaborative Shopping Session page (FIG. 15) has the following screen elements:
Chat Messages window 1553, 1554
Avatars images 1034 of session users 1045a displayed in 1551a, 1551b, 1551c
Page image 1049 per avatar of pages shared 1048 by session users 1045a displayed in 1552a, 1552b, 1552c

### Chat Messages Window

Each of the Collaborative Shopping Session pages (FIG. 15) contains one chat window 1553, 1554. The window is unique to that Session 1044 and the session users 1045a only. As in all standard chat message windows, this chat window 1553 displays messages 1047 that are created by the user 232a and any other session users 1045a. Each chat message 1047 will start with the user's name of the user 232a that sent the chat message 1047. A chat message 1047 is entered into the chat field 1554 and displayed in the chat window 1553. Again, only session users 1045a of the same session 1044 will see the chat messages 1047.

Open vs. Closed Sessions

Sessions 1044 can be open or closed. If open, any session user 1045a can invite other users 232a to participate. If closed, only the initiator of the session 1044 can invite other users 232a to join the session 1044. In an open session 1044, the initiator of the session 1044 is not asked to approve users 232a invited to the session 1044 by other session users 1045a. As a new user 232a is joining the session 1044, all session users 1045a will have some indicator (such as the avatar image 1034 changing to “jsmith is joining”) that a new user 232a is joining the session 1044. A session 1044 can be set to open or closed by the initiator of the session 1044, but once set to open, cannot be closed again. To open a session 1044, the initiator clicks the closed lock button 1550, which sets it to a disabled open lock button 1550.

Open/Closed lock icon 1550:
Used to set a session 1044 to open
All users 232a can view this icon 1550
Only the Initiator of the Session 1044 can set the session 1044 to open.
All sessions 1044 default as closed

### Ending a Session

To end a session 1044, the user 232a selects the x in the active session tab 1502a, 1502b. If an initiator ends a session 1044 the impact varies based on whether the session 1044 is open or closed. If open, the session 1044 continues for all remaining session users 1045a. To simplify this, once a session 1044 is set to open, the lock is disabled and the session 1044 cannot be closed again. If a session 1044 is closed and the initiator ends the session 1044, the session 1044 will end for all session users 1045a as well. If a participant ends a session 1044, the session 1044 ends only for them. The other session users 1045a receive a notice that the user 232a has left the session 1044.

### Avatars Per Session

The user's avatar 1551a is always the left-most image 1551a. Each avatar image 1551a, 1551b displays the name of the user it represents, except for the user's avatar 1551a, which will display “Me” to help distinguish it from the others. If a user 232a hovers over any avatar image 1551a, 1551b, they will see a message that indicates the Shopping Status 1504 of that user 232a, if the user 232a has provided a shopping status. Empty avatar slots 1551c are represented by a silhouette of an avatar. The initiator of a session 1044 will see the text “Invite”. The other session users 1045a will see “Invite” if the session 1044 is open, otherwise they will see no text. If a user 232a clicks an empty slot 1551c with the text “Invite”, the Individual Invitation process will be started.

### Page Images Per Avatar

Below the avatar image 1551a, 1551b, 1551c of each user 232a is a slot to display the page image 1552a, 1552b that user 232a has shared if they have shared a page. If a user 232a has not shared a page, a blank space 1552c will appear instead.

Below each page image 1552a, 1552b is a hyperlink. For the user's 232a page image 1552a the hyperlink is “Share My Page”. For the page images 1552b of the other users 232a, the hyperlink is “View Page”. Selecting “Share My Page” will push the user's 232a page (page image 1552a & behind the scenes the URL) to all other session users 1045a if the page is one of the valid page types. Selecting a “View Page” link opens the session user's 1045a page to be viewed by the user 232a.

It is important to note that the user 232a can share a different page per active session tab 1502a, 1502b. For example, on the Holly Madison session corresponding to active session tab 1502a in FIG. 15, the user 232a could share a camera, but on the Fun Summer Dresses, Inc. (which is a seller) session 1044, the user 232a could share one of Fun Summer Dresses' products. And in yet another, they could be sharing nothing. In order for separate sessions 1044 to be meaningful, it is important that they each support distinct sharing and distinct chat.

It is also important to note that a user 232a could invite the same user 232a to more than one session 1044. For example, Holly Madison could be invited to the Fun Summer Dresses, Inc. session 1044 as well so that she can participate in the conversation with that seller.

### Notifications

Similar to how notifications appear in the Collaborative Shopping Bar (FIG. 13) as described in the notifications section of Collaborative Shopping Bar (FIG. 13). Key events should be displayed within the collaborative shopping Session (FIG. 15) if the session 1044 is visible to the user 232a. These events include:
Visual display of pending invitation acceptance or rejection.
Notice of invitations accepted (regardless of whether invitation sent by user 232a or in case of open session 1044, by another session user 1045a)
Notice of session user 1045a leaving a session 1044
Notices of new pages shared 1048
Notices of new chat messages 1047
Notices of invitation requests
Notices of a closed session 1044 ended by its initiator

### New Chat Notifications:

For new chat messages 1047, no notification should appear, the new chat message 1047 should simply append to the bottom of the chat window 1553.

### Invitations To Other Member's Sessions Notifications:

After an invitation has been sent to a system user 232a, one of the avatar positions 1551c should be held until the user 232a has accepted or rejected. To visually display this, the following messages should be displayed over the empty silhouette image (silhouette image represents an open session position). The messages are:

Pending Invitation: “Pending Invitation: <USERID>”

Accepted Invitation: “<USERID> joining session 1044.”

Rejected Invitation: “<USERID> rejected invitation.”

### Session User Leaving Notifications:

When a session user 1045a leaves a session 1044 by closing the active session tab 1502a, 1502b, the following message should be displayed over the avatar 1551b, 1551c for the other session users 45a:

Session User 1045 leaving session 1044: “<USERID> has left.”

### New Pages Shared Notifications:

When a new page has been shared by a session user 1045a, an outline should appear around the page image 1049. The outline should disappear if the user 232a clicks the “View Page” hyperlink under that image 1552b, 1552c or after 30 seconds has elapsed.

### Invitation Request Notifications:

For Invitation Request notifications, a different type of notification is used, which is a pop-over that covers the entire collaborative shopping bar (FIG. 13).

### Close Session Ended by Session Initiator Notifications:

When a closed session 1044 is ended by its initiator it ends for all session users 1045a. When ended, the session 1044 should be changed from active to inactive, and the session tab's title 1502a, 1502b should change to “Session Closed”. After 1 minute, this title should change to an inactive tab 1503a, 1503b with a title of “Start Session”. Regardless of its title, when an inactive tab 1503a, 1503b is selected the process is the same, the invitation process is started.

In the Collaborative Shopping Session page (FIG. 15) the user 232a can select “Share My Page” which will publish/push the user's 232a page to all other session users 1045a if it is a valid page. If the user 232a is on a non-valid page, the “Share My Page” hyperlink will be disabled. When a user 232a selects the “Share My Page” hyperlink for a valid page, the following actions occur:

User's page image 1552b below their avatar image 1551b changes to the page they are currently accessing

User's page image 1552a is pushed to the session users 1045a user interfaces 1046 in the currently active session 1044, overwriting any previously shared page 1048.

When a session user 1045a selects “View Page” for the user's shared page 1552b, they will see the current page rather than any previously shared page 1048.

### Viewing

If another session user 1045a has shared a page, there will be a page image 1552b below that user's avatar image 1551b, 1551c and a “View Page” hyperlink below the page image 1552b. If the user 232a has not shared a page, a grayed block will appear in place of the page image 1552c. When a user 232a clicks a “View Page” hyperlink, their screen changes to the page shared while the Collaborative Shopping Session (FIG. 15) page-over remains the same. The shared page 1048 has the following attributes:
The screen has some type of visual indicator around the screen to make it clear that they are on another users 232a page.
Two buttons are overlaid onto the shared page 1048:
   One button allows the user 232a to switch back to his or her own web page.
   One button allows the user 232a to set the shared page 1048 as his or her own web page.

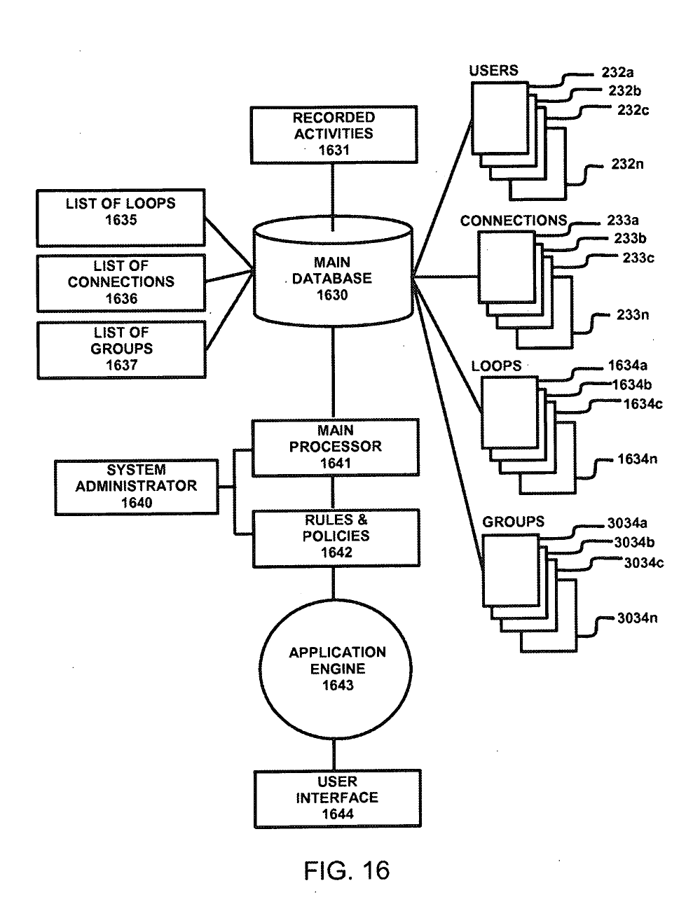

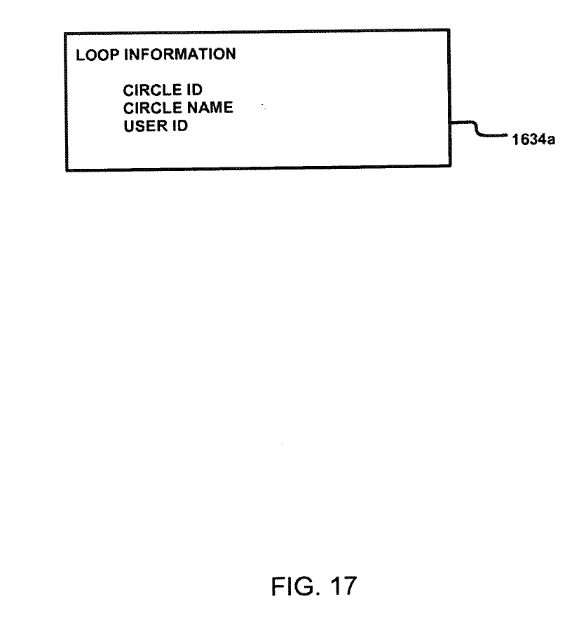

Focusing now on the Loop management functionality of the present disclosed subject matter, FIG. 16 is a diagram focusing on the transfer, storage, and processing of data in an exemplary system supporting the disclosed subject matter. FIG. 17 is a diagram of an exemplary database entry for storing information about a Loop in an exemplary system supporting the disclosed subject matter. The Main Database 1630 stores all data or references to external data, for example, images. The following types of data are managed by the Main Database 1630:

User Records 232a-232n, shown in FIG. 3A: When a user registers with the system 100, the system 100 generates a User record 232a-232n including a User ID generated by the system 100 as a unique identifier for the user, First Name, Last Name, Company Name, Username as selected by the user, Password, and Email Address of the user.

Each time one user establishes a connection with another user, the system generates a Connection record 233a-233n, shown in FIG. 3B, which identifies the Connection ID generated by the system 100, Owner User ID of the user initiating the connection, To User ID of the user receiving the connection request, Connection Type to indicate how the connection was made, and Circle ID to indicate the loop the connection is assigned.

Loops 1634a-1634n: A Loop 1634a includes a CIRCLE ID and a CIRCLE_NAME as well as multiple links to USER Ids to indicate the users 232a-232n assigned to the Loop 1634a.

Each time a user creates a Loop 1634a, it is added to the Lists of Loops 1635 are used to set privacy for shared information, indicate availability, and to assign a loop to a connection.

List of Connections 1636 are used to assign a connection to a Loop.

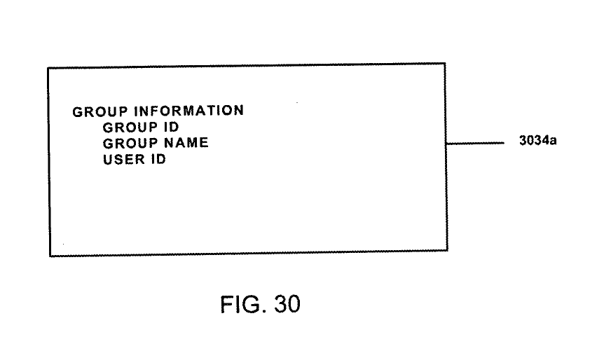

Groups 3034a-3034n: As shown in FIG. 30, a Group 3034a includes a GROUP ID and a GROUP NAME as well as multiple links to USER Ids to indicate the users 232a-232n assigned to the Group 3034a.

All Recorded Activities 1631, such as inviting a user to a Shared Shopping session, accepting an invitation, or rejecting an invitation.

The Main Processor 1641 provides the capability to connect users together, and to indicate when users are available to connect because they have logged into the website. The Rules & Policies 1642 control the visibility and privacy of a user as viewed by other users that have established a connection or selected as a favorite by the user. The System Administrator 1640 is responsible for establishing, maintaining, and supporting the Main Processor 1641 and Rules & Policies 1642. The Application Engine 1643 provides the capabilities to support sending and receiving invitations, configuring privacy for a field or set of fields, and for modifying whether other users see a user as online or offline based on availability settings. The user interface 1644 displays the user's current availability setting, current privacy setting per field or sets of fields, list of connections 1636, and list of Loops 1635, and list of Groups 1637.

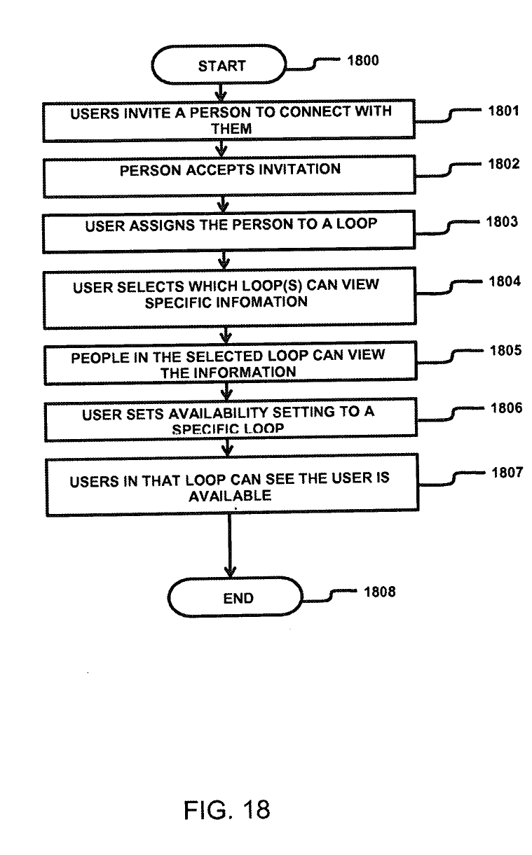

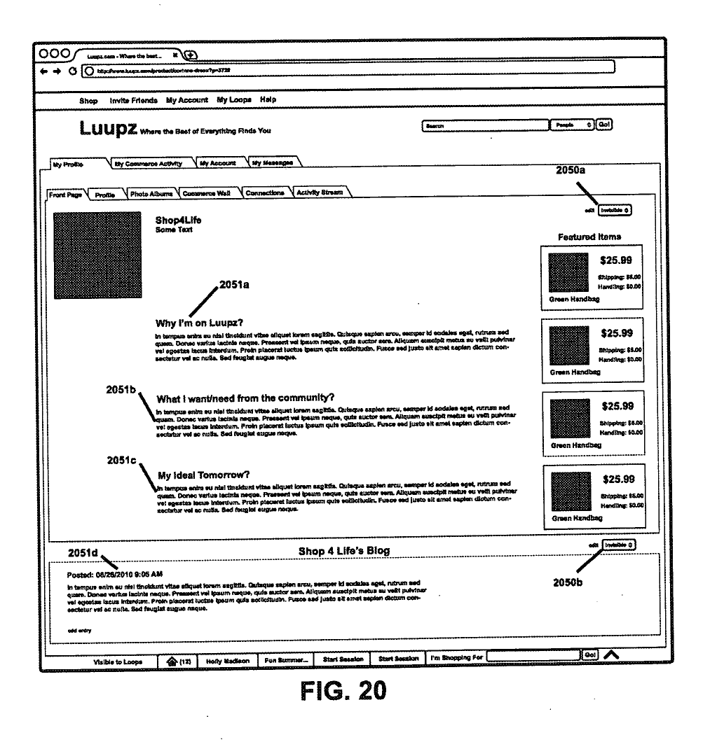

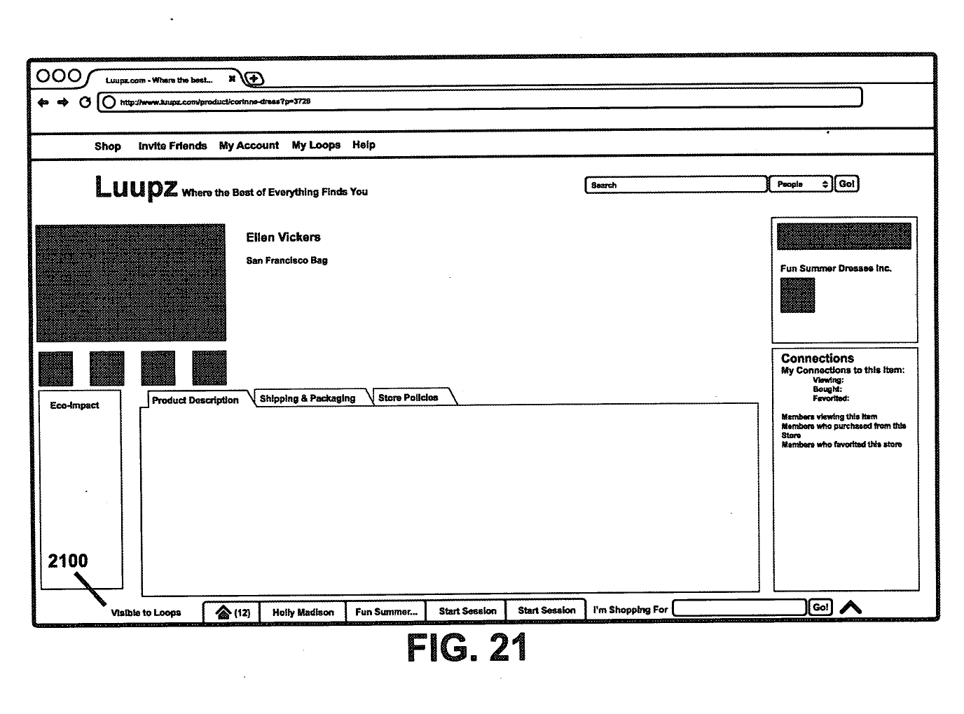

FIG. 18 is a flow diagram (flow chart) of an exemplary process of managing a Loop in an exemplary system supporting the disclosed subject matter. The process starts with step 1800. In step 1801, a user 232a invites a user 232a to establish a connection 233a with him or her by selecting the “Expand My Zecozi Loop™” button at 1900. In step 1802, a user 232a accepts an invitation from another user 232a, which adds the invited user 232a to the user's 232a list of connections 1636 and records this activity 1631 to be stored in the main database 1630 and displayed in the user interface 1644. The list of connections 1636 is determined by the Rules & Policies 1642 as processed by the Main Processor 1641 and configured by the System Administrator 1640. In step 1803, a user 232a assigns the newly connected user to a Loop 1634a from the List of Loops 1635 with the Loops dropdown field 1902. In step 1804, the user 232a selects using the privacy dropdowns such as 2050a-2050b (FIG. 20), which Loops 1634a-1634n from the List of Loops 1635 can view fields or sets of fields on the user interface (also “web page” or “website”) such as 2051a-2051d. In step 1805, users within the selected Loops 1634a-1634n can view the fields or sets of fields such as 2051a-2051d based on the Application Engine 1643 granting view rights per the user's Loop 1634a settings. In step 1806, the user 232a sets the user's 232a availability to all other users 232a-232n on the website, by selecting a specific loop 1634a in the dropdown field at 2100 (shown in FIG. 21). In step 1807, the users 232a that belong to the specific Loop 1634a selected in 2100 can view that the user 232a is online. The process ends with step 1808.

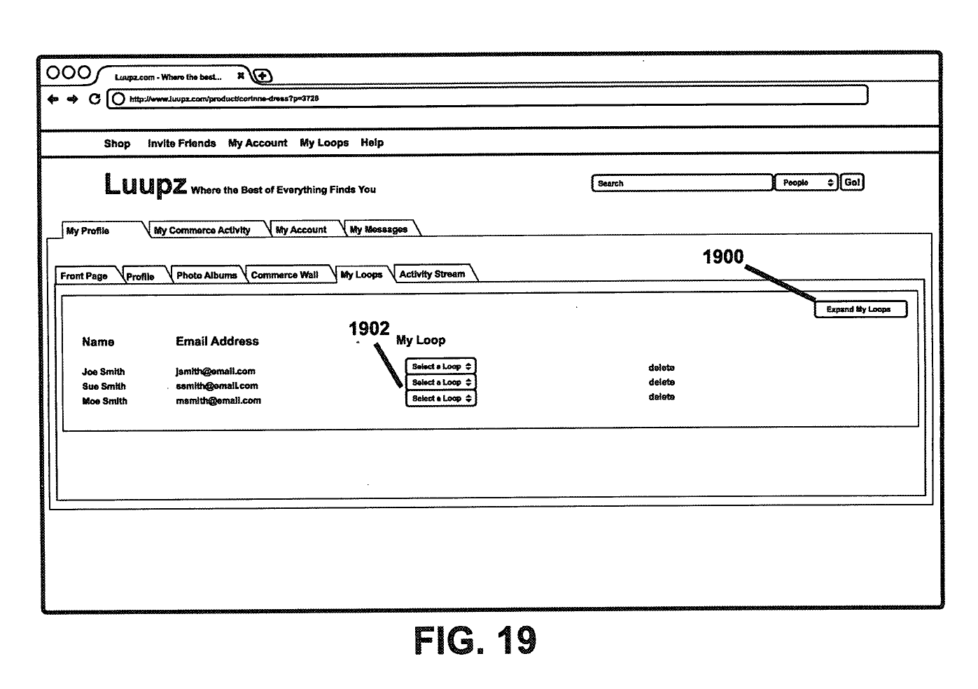

### System Screens Overview—FIGS. 19-21

### Loops User Interface—FIG. 19

### Invitation

The user 232a invites another user 232b to be connected to him or her by selecting the “Expand My Zecozi Loop™” button 1900. If the user 232b accepts the invitation, this forms a connection 233a between the users 232a-232b.

### Degrees

A direct connection 233a from one user 232a to another user 232b is considered a 1st degree connection 233a. If the user 232b also has a connection 233b to a different user 232c and that user 232c does not have a connection 233n to user 232a, then the connection 233n from user 232a to user 232c is considered a 2nd degree connection 233n. If at any point the user 232a and the user 232c decide to form a connection 233c between themselves, their connection 233c changes from a 2nd degree to a 1st degree. In addition if user 232c has a connection 233d with another user 232d and the original user 232a does not have a connection 233n to the user 232d, then the connection 233n between user 232a and user 232d is considered a 3rd degree connection 233n. The system (“website”) supports multiple degrees of connections 233a-233n and allows the user 232a to view whether 1st, 2nd, or 3rd degree connected users 232b-232n have purchased a product, favorited a product, purchased from a seller, etc. if those 1st, 2nd, or 3rd degree users 232b-232n choose to publish their purchases and favorites. The degree of connection 233a between users 232a-232n is calculated by the Application Engine 1643 per rules defined by the Rules & Policies 1642. Degrees of connection 233a are displayed in the User Interface 1644 graphically and numerically near a users 232a name.

### Assigning Connections to Loops

Each connected user 232a-232n can be assigned to a Loop 1634a from the List of Loops 1635 via the “Select a Loop” dropdown field as shown in 1902. Changing the value of this dropdown field 1902 can change a user 232a from one Loop 1634a to another Loop 1634b at any time.

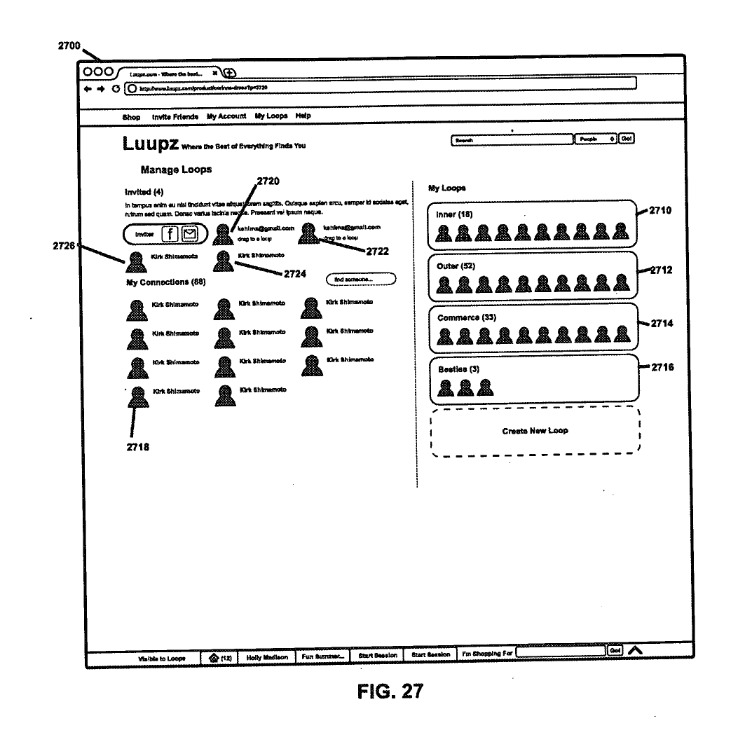

FIG. 27 is a diagram of a user interface for managing one or more Loops 1634a-1634n in an alternative embodiment of a system in accordance with the present disclosed subject matter. In this user interface, which is a web page 2700, a user 232a may assign a given Connection 233a-233n to multiple Loops 1634a-1634n simultaneously. The user 232a assigns a Connection 233a-233n to Loops 1634a-1634n by dragging the Connection's avatar 2718 into one or more visual representations 2710, 2712, 2714, and 2716 of Loops 1634a-1634n. The user 232a may provisionally assign an Invited Connection 2720 to one or more of Loops 1634a-1634n in a similar manner. Invited Connections appear as placeholders 2720, 2722, 2724, and 2726 in the visual representations 2710, 2712, 2714, and 2716 of the user's 232a Loops 1634a-1634n until the Connection Request is Accepted.

### Privacy—FIG. 20

### Privacy

Privacy of a user's 232a information can be controlled by Loop 1634a or set to be visible to all users of the system 100 (“website”) or set to be visible to no users on the system by setting the value of the privacy dropdown such as 2050a and 2050b. If set to Invisible, no user's 232a-232n can view the information. If set to Visible for a specific Loop 1634a, only the users 233a-233n the user 232a assigned to that Loop 1634a can view the information. If set to Visible to All, all users 232a-232n on the website can view the information. The user 232a can select fields or sets of fields such as 2051a-2051d to different privacy settings. This enables the user 232a to tightly control which information is viewable by which user 232b or set of users 232b-232n.

### Availability—FIG. 21

### Availability

User 232a selects his or her availability to other users 232a-232n by the Availability dropdown 2100. If a user 232a selects Invisible, the user 232a appears offline to all other users 232b-232n. If the user sets his or her Availability to an individual Loop 1634b, a set of Loops 1634a-1634c, or all Loops 1634a-1634n, the user 232a appears to the users 232b-232n of those Loops 1634a-1634n as online. If the user 232a sets his or her Availability to “Visible to All,” the user 232a appears online to all users 232a-232n of the system (“website”). A user 232a that is online can be invited to participate in Collaborative Shopping sessions where users 232a-232n can shop together and communicate with each other in real-time.

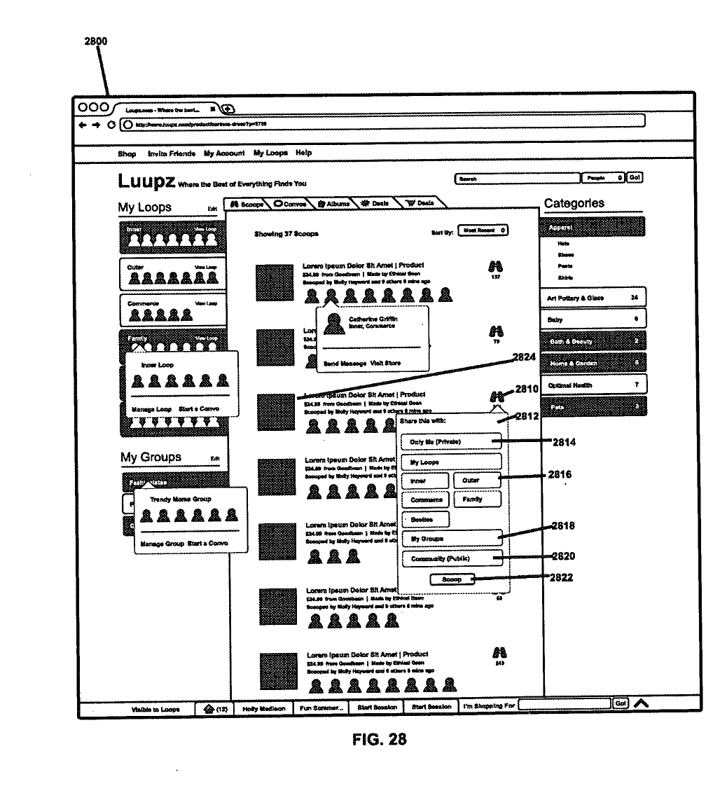

### Sharing Information—FIG. 28

FIG. 28 is a diagram of a user interface for managing the sharing of an item of information in an alternative embodiment of a system in accordance with the present disclosed subject matter. The user interface is a web page 2800. A user 232a can choose to share data fields on their profile 234a, availability status, and individual pieces of published content (e.g., purchases, items indicated as favorites, conversations, etc.). Using the web page 2800, the user 232a may share content with multiple Loops 1634a-1634n. In this example, user 232a has clicked on an icon 2810 to designate a particular listing 2824 as a favorite item. Pop-up box 2812 reveals controls 2814, 2816, 2818, and 2820 for specifying which users 232a-232n of the system will have access to the fact that user 232a has designated the listing 2824 as a favorite. Toggle 2812, if clicked, sets the information to be private and not shared with anyone else. Toggles in section 2816 allow user 232a to set which of the user's 232a Loops 1634a-1634n to share the information with. Toggle 2818 allows the user 232a to specify that the information is to be shared with Groups 3034a-3034n that the user 232a is associated with. Toggle 2820 allows the user 232a to share the information will all of the other users 232b-232n of the system, thereby making the information public. Finally, button 2822, if clicked, causes the listing 2824 to be designated as a favorite of user 232a and for this fact to be shared with the user 232a-232n specified in pop-up box 2812.

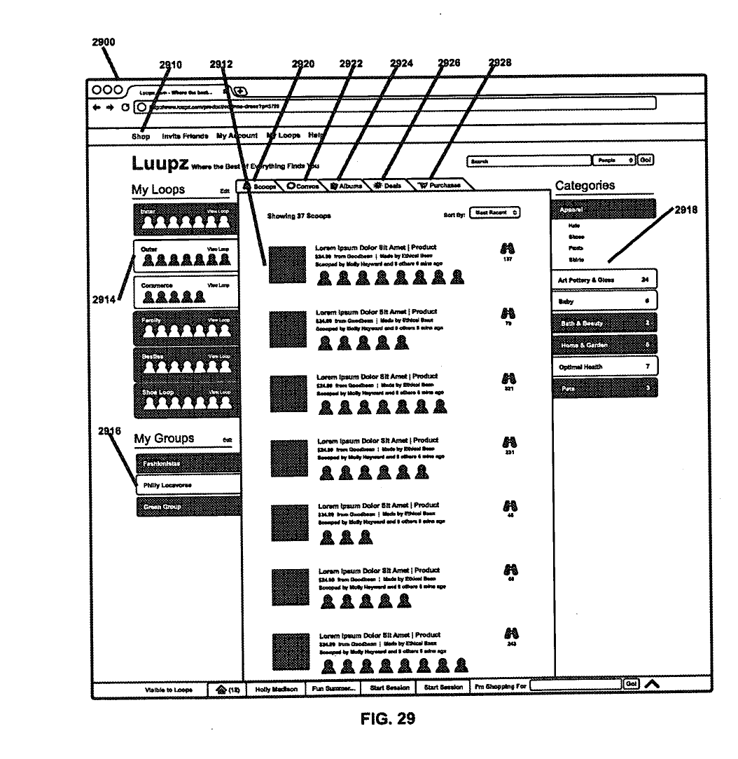

### Dashboard—FIG. 29

FIG. 29 is a diagram of a user interface for presenting recent shared activity and information to a user in an alternative embodiment of a system in accordance with the present disclosed subject matter. The user interface in this example is a web page 2900. In this particular embodiment, this user interface appears when a user 232a logs into the system. The user interface may be accessed at any time by clicking on the logo 2910. As shown in this example, section 2912 shows a set of items designated as favorites by users 232b-232n of the system. The user 232a may use toggles appearing in section 2914 to specify which of the Loops 1634a-1634n belonging to the user 232a the favorite items appearing in section 2912 pertain to. Likewise, the user 232a may choose specific Groups 3034a-3034n that the user 232a is associated with, using toggles appearing in section 2916, to narrow the set of favorite items appearing in section 2912. In section 2918, the user 232a may use toggles to further limit the set of favorite items to specific categories of products in listings 235a-235n. Tabs 2920, 2922, 2924, 2926, and 2928 across the top of section 2912 allow the user 232a to instead view other shared information from users 232b-232n of the system, including conversations, photo albums, deals on product in listings 235a-235n, and purchases.

It is to be understood that all communication between computers and databases as disclosed herein is possible because they are connected together as part of the same computer or networked together via a wired or wireless network. It should also be understood that the databases discussed herein could be embodied in one or more flat files or in relational databases, and that they could be stored in the memory of one computer or distributed across multiple computers.

The above-described processes, including portions thereof, can be performed by software, hardware, and combinations thereof. These processes and portions thereof can be performed by computers, computer-type devices, workstations, processors, micro-processors, other electronic searching tools with memory, and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the disclosed subject matter have been described, so as to enable one of skill in the art to practice the present disclosed subject matter, the preceding description is intended to be exemplary only. It should not be used to limit the scope of the disclosed subject matter, which should be determined by reference to the following claim(s).

### INDUSTRIAL APPLICABILITY

It should be understood from the above disclosure that the invention can be implemented, for example, as methods and systems that employ computers and components adapted to network the computers together. It should also be understood that the invention has benefits when used in industry, as outlined in the DISCLOSURE OF INVENTION section.

1. A system for allowing at least two users of the system to participate in at least one collaborative shopping session, wherein said users simultaneously and collaboratively share information and opinions about products, services, and/or sellers of products and/or services viewable on an electronic communications network, and purchase one or more said products and/or services, the system comprising:
at least one database server connected to said electronic communications network and a database, said database server having a processor, a memory containing processor-executable instructions, and a connection to a database configured to store information regarding a plurality of users of the system and the relationship between the plurality of users and information regarding products and/or services available to be purchased;
at least one application server connected to said electronic communications network, said application server containing a processor, and a memory containing processor-executable instructions for interacting with said plurality of users to allow said users to view information regarding said products and/or services available to be purchased, to purchase said products and/or services, and to communicate with each other; and
a plurality of client computers each having a connection to said electronic communications network, a processor, and a memory containing processor-executable instructions for interacting with and utilizing the functionality of said at least one application server through a user interface through said electronic communications network, said user interface including a panel adapted for managing a collaborative shopping session and interacting with users participating in said collaborative shopping session through said plurality of client computers.

2. The system of claim 1, wherein:
said panel partially overlays an area adapted for rendering information in said database server pertaining to a product or service,
said panel includes user interface elements pertaining to the collaborative shopping session, said user interface elements comprising:
an area adapted for displaying one or more avatars, each avatar being an image associated with a user participating in the collaborative shopping session;
an area in which text can be typed and sent to said users participating in said collaborative shopping session;
an area adapted for displaying said text to users in the collaborative shopping session; and
an area which, when activated by a first user participating in said collaborative shopping session, causes said application server to send an invitation to at least one other user participating in said collaborative shopping session to view a webpage being viewed by the first user, wherein, upon said at least on other user accepting said invitation, said webpage is rendered in each of said at least one other user's client computer in said area adapted for rendering a webpage.

3. The system of claim 2, wherein said user interface further comprises a plurality of tabs bordering said panel, wherein at least two of said plurality of tabs is each associated with a different collaborative shopping session and activating one of the tabs associated with a collaborative shopping session causes the panel to display said user interface elements pertaining to the collaborative shopping session.

4. The system of claim 3, wherein activating at least one of the plurality of tabs causes a new collaborative shopping session to be initiated.

5. The system of claim 1, wherein said database stores information regarding relationships between users using the system, such that, with respect to information regarding a particular user, one or more other users are granted access to view such information according to one or more privacy settings set by the particular user, based on the relationship between the particular user and said one or more other users.

6. The system of claim 2, wherein said database stores information regarding relationships between users using the system, such that, with respect to information regarding a particular user, one or more other users are granted access to view such information according to one or more privacy settings set by the particular user, based on the relationship between the particular user and said one or more other users.

7. The system of claim 5, wherein said database stores information indicating that at least two users have agreed to be connected, the resulting connection at least partially defining the relationship between the at least two users for information-sharing purposes.

8. The system of claim 6, wherein said database stores information indicating that at least two users have agreed to be connected, the resulting connection at least partially defining the relationship between the at least two users for information-sharing purposes.

9. The system of claim 7, wherein said database stores information indicating that a plurality of users are connected together with a particular user, forming a set of connections, and access to view information pertaining to the particular user is determined based on one or more privacy settings pertaining to said set of connections.

10. The system of claim 8, wherein said database stores information indicating that a plurality of users are connected together with a particular user, forming a set of connections, and access to view information pertaining to the particular user is determined based on one or more privacy settings pertaining to said set of connections.

11. The system of claim 7, wherein said database stores information representing a plurality of sets of connections each formed of a plurality of users.

12. The system of claim 8, wherein said database stores information representing a plurality of sets of connections each formed of a plurality of users.

13. The system of claim 7, wherein the application server, database server, and at least one client computer further comprise computer-executable instructions for allowing a user operating a client computer to designate that the user favors a particular product, service, or seller of products and/or services.

14. The system of claim 8, wherein the application server, database server, and at least one client computer further comprise computer-executable instructions for allowing a user operating a client computer to designate that the user favors a particular product, service, or seller of products and/or services.

15. The system of claim 13, wherein the application server, database server, and at least one client computer further comprise computer-executable instructions allowing said user designating a particular product, service, or seller of products and/or services to share the designation of said product, service, or seller as a favorite with no other users, users in one or more sets of connections to which said user is connected, or all other users using the system.

16. The system of claim 14, wherein the application server, database server, and at least one client computer further comprise computer-executable instructions allowing said user designating a particular product, service, or seller of products and/or services to share the designation of said product, service, or seller as a favorite with no other users, users in one or more sets of connections to which said user is connected, or all other users using the system.

17. The system of claim 15, wherein the application server further comprises computer-executable instructions for sending through the electronic communications network a first set of search results relating to products, services, or sellers which are ranked based on relevance to keyword search criteria and a second set of search results which are ranked based on keyword search criteria coupled with information pertaining to whether one or more other users connected with a particular user submitting the search query have indicated that they favor the product, service, or seller of the product or service.

18. The system of claim 16, wherein the application server further comprises computer-executable instructions for sending through the electronic communications network a first set of search results relating to products, services, or sellers which are ranked based on relevance to keyword search criteria and a second set of search results which are ranked based on keyword search criteria coupled with information pertaining to whether one or more other users connected with a particular user submitting the search query have indicated that they favor a product, service, or seller of the product or service.

19. The system of claim 15, wherein the application server further comprises computer-executable instructions for sending through the electronic communications network to a client computer operated by a first user information pertaining to activities that one or more other user using the system has conducted, the activities including designating a product, service, or seller as a favorite, conducting a conversation with another user using the system, purchasing a product or service, offering a product or service for sale, or posting an image,
wherein the information is sorted based on how recently each activity occurred and is filtered based on criteria submitted through the client computer, said criteria pertaining to products and/or services, and/or connections of said first user operating the client computer.

20. The system of claim 16, wherein the application server further comprises computer-executable instructions for sending through the electronic communications network to a client computer operated by a first user information pertaining to activities that one or more other user using the system has conducted, the activities including designating a product, service, or seller as a favorite, conducting a conversation with another user using the system, purchasing a product or service, offering a product or service for sale, or posting an image,
wherein the information is sorted based on how recently each activity occurred and is filtered based on criteria submitted through the client computer, said criteria pertaining to products and/or services, and/or connections of said first user operating the client computer.
